(19) United States
(12) Patent Application Publication
(10) Pub. No.: US 2025/0100151 A1
(43) Pub. Date: Mar. 27, 2025

(54) CONTROL METHOD OF ROBOT AND ROBOT SYSTEM

(71) Applicant: SEIKO EPSON CORPORATION, Tokyo (JP)

(72) Inventor: Tomokazu HIRABAYASHI, Azumino-shi (JP)

(21) Appl. No.: 18/890,808

(22) Filed: Sep. 20, 2024

(30) Foreign Application Priority Data
Sep. 21, 2023 (JP) 2023-156379

(51) Int. Cl. B25J 9/16

(52) U.S. Cl. CPC B25J 9/1694

(57) ABSTRACT

A control method of a robot includes: an inertial information reception step of receiving an output signal from an inertial sensor that measures an operation of an arm; a first feedback gain adjustment step of performing adjustment to increase a feedback gain to be multiplied by the output signal or a signal generated from the output signal, according to a change in the operation of the arm; a drive control step of controlling a drive of the arm by using the feedback gain increased in the first feedback gain adjustment step; and a second feedback gain adjustment step of performing adjustment to decrease the feedback gain after elapse of a predetermined time from the first feedback gain adjustment step.

### CROSS-REFERENCE TO RELATED APPLICATIONS

The present application is based on, and claims priority from JP Application Serial Number 2023-156379, filed Sep. 21, 2023, the disclosure of which is hereby incorporated by reference herein in its entirety.

### BACKGROUND OF THE INVENTION

### 1. Technical Field

The present disclosure relates to a control method of a robot and a robot system.

### 2. Related Art

A robot described in JP-A-2005-242794 includes a base, a first arm coupled to the base to be rotationally movable, a first motor that drives the first arm, a first angle sensor that detects a rotation angle of the first motor, a first angular velocity sensor that detects an angular velocity of the first arm with respect to the base, a second arm coupled to the first arm to be rotationally movable, a second motor that drives the second arm, a second angle sensor that detects a rotation angle of the second motor, and a second angular velocity sensor that detects an angular velocity of the second arm with respect to the first arm. A rotational movement angle of the first arm is detected by using an output of the first angle sensor and an output of the first angular velocity sensor, and a rotational movement angle of the second arm is detected by using an output of the second angle sensor and an output of the second angular velocity sensor. Further, detection results are fed back to perform vibration damping control of the robot.

However, with the above-described method, vibrations in operating directions of the first and second arms can be reduced, but vibrations in the other directions, for example, vibrations in a direction along a rotational movement axis, cannot be reduced. In addition, when vibrations occur in a direction different from the operating direction, in the above-described method, the vibrations are fed back, so that operations of the first and second arms may become unstable, thereby potentially reducing the vibration damping effect. That is, in the method of JP-A-2005-242794, excellent vibration damping control cannot be performed.

### SUMMARY OF THE INVENTION

According to an aspect of the present disclosure, there is provided a control method of a robot, including: an inertial information reception step of receiving an output signal from an inertial sensor that measures an operation of an arm; a first feedback gain adjustment step of performing adjustment to increase a feedback gain to be multiplied by the output signal or a signal generated from the output signal, according to a change in the operation of the arm; a drive control step of controlling a drive of the arm by using the feedback gain increased in the first feedback gain adjustment step; and a second feedback gain adjustment step of performing adjustment to decrease the feedback gain after elapse of a predetermined time from the first feedback gain adjustment step.

According to another aspect of the present disclosure, there is provided a robot system including: a base; an arm that is driven with respect to the base; an inertial sensor that detects an operation of the arm; and a controller that controls the drive of the arm, in which the controller receives an output signal from the inertial sensor, performs adjustment to increase a feedback gain to be multiplied by the output signal or a signal generated from the output signal, according to a change in the operation of the arm, controls the drive of the arm by using the feedback gain after the adjustment, and performs adjustment to decrease the feedback gain after elapse of a predetermined time from the increase of the feedback gain.

### BRIEF DESCRIPTION OF DRAWINGS

FIG. 1 is a block diagram illustrating a configuration of a robot system according to a first embodiment.

FIG. 2 is a diagram illustrating a robot provided in the robot system of FIG. 1.

FIG. 3 is a block diagram illustrating a controller provided in the robot system of FIG. 1.

FIG. 4 is a diagram illustrating a two-inertia system model of a rotational movement portion of the robot.

FIG. 5 is a graph illustrating changes in an angular acceleration command, a driving element angular velocity, a driven element angular velocity, and a deflection angular velocity during a PTP operation of an arm.

FIG. 6 is a timing chart illustrating an example of processing of adjusting a deflection angular velocity feedback gain.

FIG. 7 is a graph illustrating a residual vibration suppression effect of the arm.

FIG. 8 is a flowchart illustrating a control method of the robot.

FIG. 9 is a timing chart illustrating an example of processing of adjusting the deflection angular velocity feedback gain, which is performed in a robot system according to a second embodiment.

FIG. 10 is a timing chart illustrating an example of processing of adjusting the deflection angular velocity feedback gain, which is performed in a robot system according to a third embodiment.

FIG. 11 is a timing chart illustrating an example of processing of adjusting the deflection angular velocity feedback gain, which is performed in a robot system according to a fourth embodiment.

FIG. 12 is a timing chart illustrating an example of processing of adjusting the deflection angular velocity feedback gain, which is performed in a robot system according to a fifth embodiment.

FIG. 13 is a timing chart illustrating an example of processing of adjusting the deflection angular velocity feedback gain, which is performed in a robot system according to a sixth embodiment.

FIG. 14 is a timing chart illustrating an example of processing of adjusting the deflection angular velocity feedback gain, which is performed in a robot system according to a seventh embodiment.

FIG. 15 is a timing chart illustrating an example of processing of adjusting the deflection angular velocity feedback gain, which is performed in a robot system according to an eighth embodiment.

FIG. 16 is a timing chart illustrating an example of processing of adjusting the deflection angular velocity feedback gain, which is performed in a robot system according to a ninth embodiment.

FIG. 17 is a timing chart illustrating an example of processing of adjusting the deflection angular velocity feedback gain, which is performed in a robot system according to a tenth embodiment.

FIG. 18 is a timing chart illustrating an example of processing of adjusting the deflection angular velocity feedback gain, which is performed in a robot system according to an eleventh embodiment.

FIG. 19 is a diagram illustrating a robot provided in a robot system according to a twelfth embodiment.

FIG. 20 is a block diagram illustrating a controller provided in the robot system of FIG. 19.

FIG. 21 is a diagram illustrating a two-inertia system model of a linear movement portion of the robot.

FIG. 22 is a graph illustrating changes in an acceleration command, a velocity, and a velocity during an operation of a spline shaft.

FIG. 23 is a timing chart illustrating an example of processing of adjusting the deflection angular velocity feedback gain.

FIG. 24 is a graph illustrating a residual vibration suppression effect of the spline shaft.

FIG. 25 is a diagram illustrating a robot provided in a robot system according to a thirteenth embodiment.

FIG. 26 is a diagram illustrating a robot provided in a robot system according to a fourteenth embodiment.

### DETAILED DESCRIPTION OF THE INVENTION

Hereinafter, a control method of a robot and a robot system of the present disclosure will be described in detail based on embodiments illustrated in the accompanying drawings.

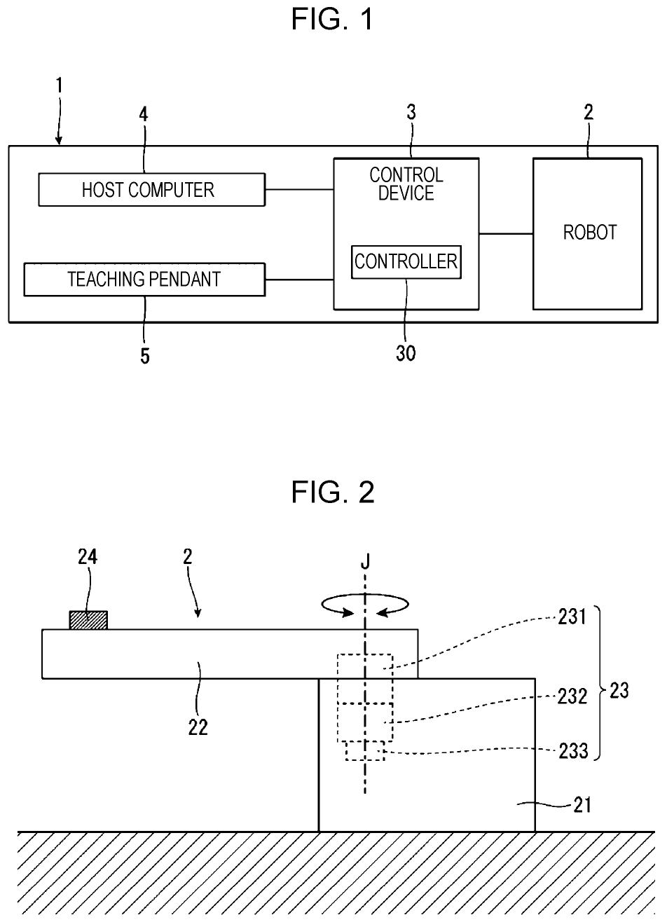

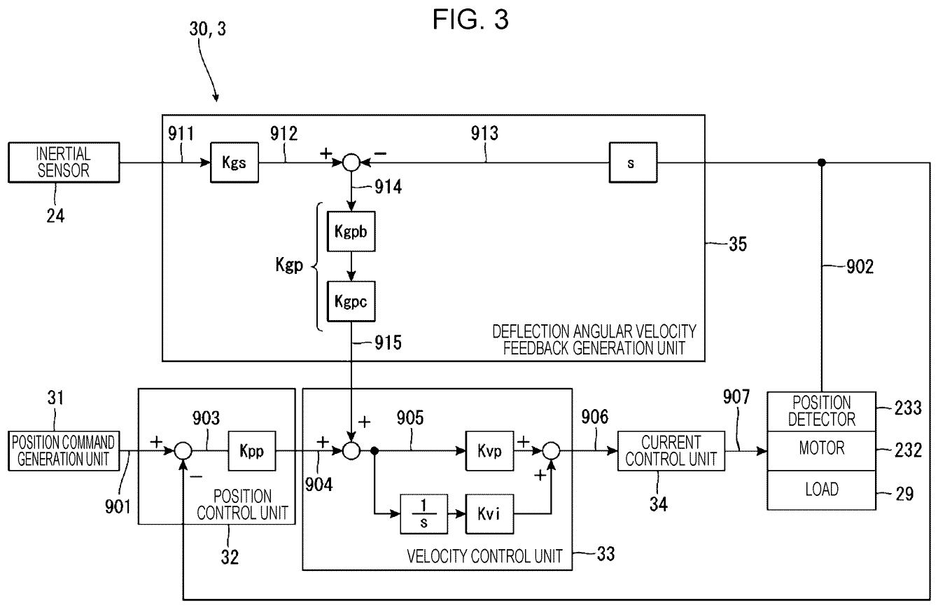

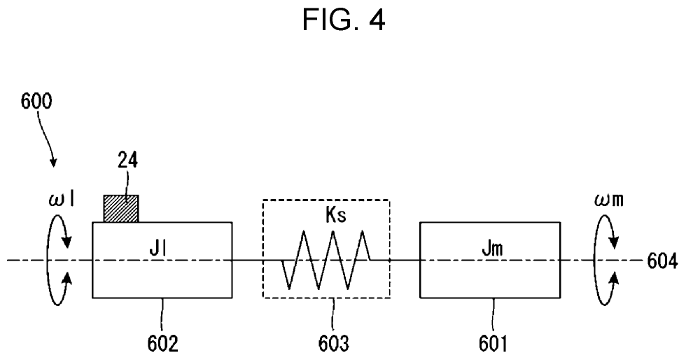

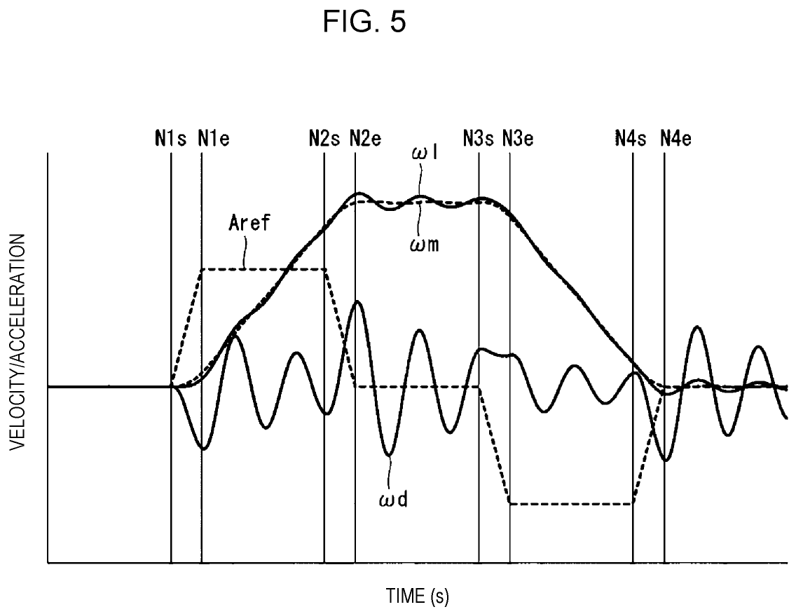

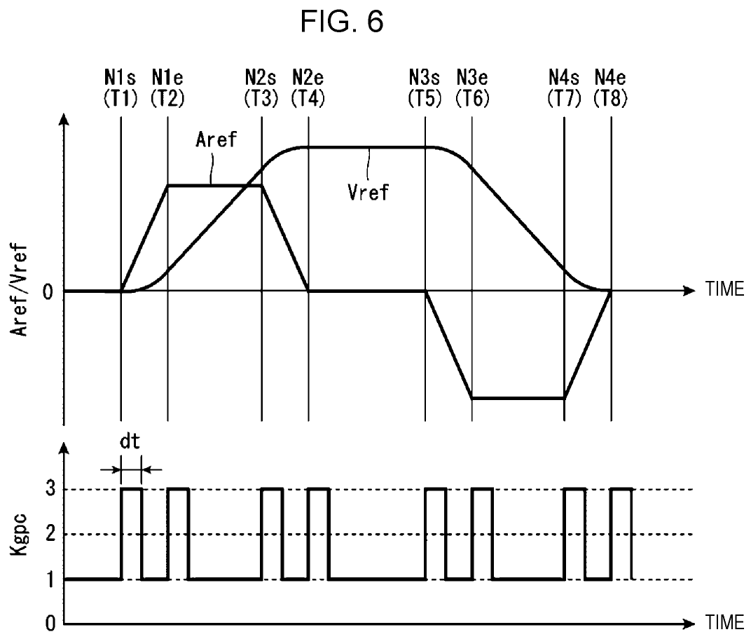

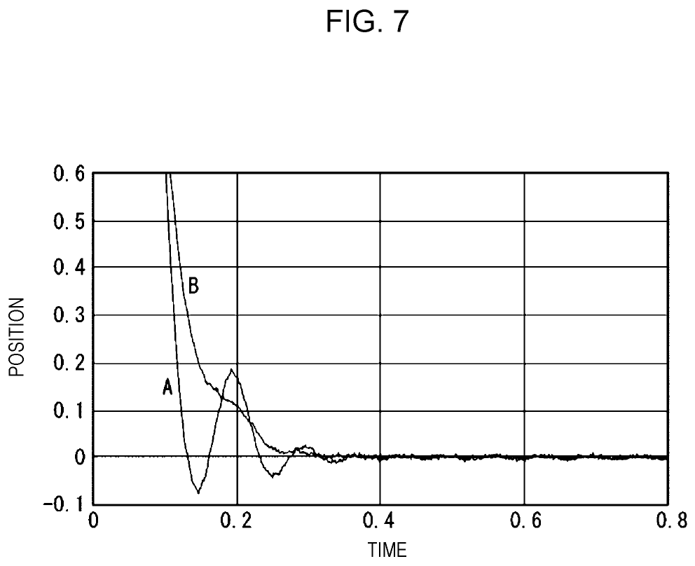

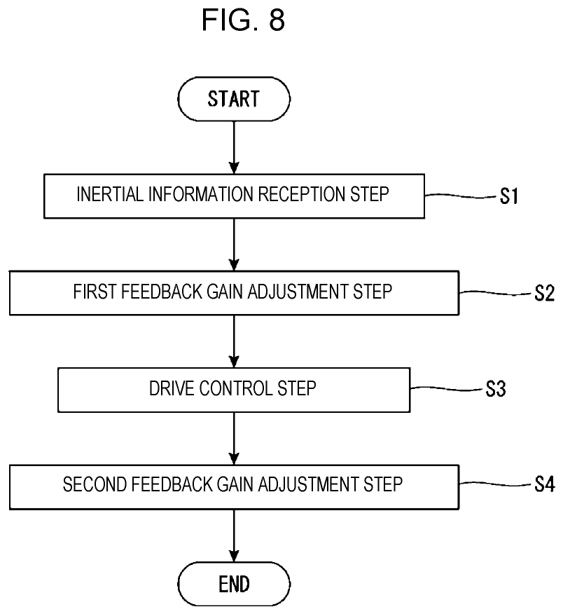

FIG. 1 is a block diagram illustrating a configuration of a robot system according to a first embodiment. FIG. 2 is a diagram illustrating a robot provided in the robot system of FIG. 1. FIG. 3 is a block diagram illustrating a controller provided in the robot system of FIG. 1. FIG. 4 is a diagram illustrating a two-inertia system model of a rotational movement portion of the robot. FIG. 5 is a graph illustrating changes in an angular acceleration command Aref, a driving element angular velocity ωm, a driven element angular velocity ωl, and a deflection angular velocity ωd during a PTP operation of an arm. FIG. 6 is a timing chart illustrating an example of processing of adjusting a deflection angular velocity feedback gain Kgp. FIG. 7 is a graph illustrating a residual vibration suppression effect of the arm. FIG. 8 is a flowchart illustrating the control method of the robot.

A robot system 1 illustrated in FIG. 1 includes a robot 2, a control device 3, a host computer 4, and a teaching pendant 5. In the host computer 4, a program for operating the robot 2 is created. The teaching pendant 5 is used to teach operations to the robot 2. In addition, the control device 3 includes a controller 30 that controls the drive of the robot 2 based on the program created by the host computer 4.

### Robot 2

As illustrated in FIG. 2, the robot 2 includes a base 21 fixed to a floor, an arm 22 that includes a base end portion coupled to the base 21 and that rotationally moves around a rotational movement axis J along a vertical direction with respect to the base 21, a drive mechanism 23 that rotationally moves the arm 22 around the rotational movement axis J with respect to the base 21, and an inertial sensor 24 disposed at a tip end portion of the arm 22. In addition, the drive mechanism 23 includes a reducer 231 that couples the base 21 and the arm 22, a motor 232 that includes a rotary shaft coupled to an input side of the reducer 231, and a position detector 233 that detects a rotation angle of a rotary shaft of the motor 232. Further, the inertial sensor 24 is an angular velocity sensor that detects an angular velocity of the arm 22 around the rotational movement axis J. Here, the inertial sensor 24 can be rephrased as an inertial sensor that measures the arm's operation in which the arm 22 rotationally moves around the rotational movement axis J. An output signal from the inertial sensor 24 includes information regarding inertia generated in the arm 22 by the operation of the arm 22, that is, inertial information. Additionally, the inertial information indicates information on inertia such as an angular velocity and an acceleration, and the inertial sensor 24 can be rephrased as a sensor that transmits the inertial information. In the present embodiment, the angular velocity is used as the inertial information.

For convenience of description, hereinafter, the rotation angle of the rotary shaft of the motor 232 is also simply referred to as a “rotation angle of the motor 232”, and the rotary shaft of the motor 232 is also simply referred to as a “motor shaft”.

### Control Device 3

The control device 3 is configured with, for example, a computer and includes a processor that processes information, a memory that is communicably connected to the processor, and an external interface. In addition, various programs executable by the processor are stored in the memory, and the processor can read and execute various programs and the like stored in the memory.

Such a control device 3 includes the controller 30 that controls the drive of the drive mechanism 23. The controller 30 has a circuit configuration illustrated in FIG. 3. The controller 30 includes a position command generation unit 31, a position control unit 32, a velocity control unit 33, a current control unit 34, and a deflection angular velocity feedback generation unit 35.

The deflection angular velocity feedback generation unit 35 first obtains a motor shaft equivalent arm angular velocity 912 by multiplying an angular velocity 911 of the arm 22, which is detected by the inertial sensor 24, by an arm angular velocity scaling coefficient Kgs. In addition, the deflection angular velocity feedback generation unit 35 obtains a motor shaft angular velocity 913, which is an angular velocity of the motor shaft, by time-differentiating a motor shaft position 902, which is the rotation angle of the motor 232 detected by the position detector 233. Next, the deflection angular velocity feedback generation unit 35 obtains a deflection angular velocity 914 by subtracting the motor shaft angular velocity 913 from the motor shaft equivalent arm angular velocity 912. Next, the deflection angular velocity feedback generation unit 35 obtains a deflection angular velocity feedback 915 by multiplying the deflection angular velocity 914 by the deflection angular velocity feedback gain Kgp (a deflection angular velocity feedback base gain Kgpb and a deflection angular velocity feedback gain coefficient Kgpc) which is a feedback gain. By using the deflection angular velocity feedback 915 obtained in this manner, the vibration suppression effect of the arm 22 can be enhanced as will be described below.

The position command generation unit 31 generates a position command 901 for the motor 232 based on the program created by the host computer 4.

The position control unit 32 first obtains a position deviation 903 obtained by subtracting the motor shaft position 902 (the rotation angle of the motor 232), which is detected by the position detector 233, from the position command 901. Next, the position control unit 32 obtains a velocity command 904 by multiplying the position deviation 903 by a position loop proportional gain Kpp.

The velocity control unit 33 is configured with proportional-integral control. The velocity control unit 33 first obtains a velocity loop command 905 by adding the velocity command 904 and the deflection angular velocity feedback 915 generated by the deflection angular velocity feedback generation unit 35. Next, the velocity control unit 33 obtains a current command 906 by adding an integral term, which is obtained by multiplying an integral value of the velocity loop command 905 by a velocity loop integral gain Kvi, to a proportional term, which is obtained by multiplying the velocity loop command 905 by a velocity loop proportional gain Kvp.

The current control unit 34 controls a current 907 for driving the motor 232 to match the current command 906, that is, controls the current 907 to follow the current command 906. The motor 232 is driven by the current 907 controlled by the current control unit 34, and a load 29 coupled to the motor 232 rotationally moves. Here, the load 29 is the sum of the inertial moments of the motor shaft and the driving elements (the reducer 231, the arm 22, the inertial sensor 24, and the like) coupled to the motor shaft.

The circuit configuration of the controller 30 is briefly described above. Next, FIG. 4 illustrates a two-inertia system model 600 of a rotational movement portion of the robot 2. In such a two-inertia system model 600, a driving element 601 having a motor shaft side inertial moment Jm and a driven element 602 having a load side inertial moment Jl are joined by a spring element 603 having a spring constant Ks. In such a two-inertia system model 600, the driving element 601 and the driven element 602 rotationally move around a rotational movement axis 604, and the spring element 603 is twisted and deformed around the rotational movement axis 604 by the rotational movement.

In the robot 2, the spring element 603 is mainly configured with the motor shaft, the reducer 231, and the arm 22. Therefore, the spring constant Ks is a combined value of the spring constants due to the deformation of the motor shaft, the reducer 231, and the arm 22. In addition, in the robot 2, the motor shaft side inertial moment Jm is mainly an inertial moment of the motor shaft. Further, in the robot 2, the load side inertial moment Jl is the sum of the inertial moments around the rotational movement axis J of the driving elements coupled to the motor shaft, that is, mainly, the reducer 231, the arm 22, and the inertial sensor 24.

Additionally, in the robot 2, the motor shaft equivalent arm angular velocity 912 obtained by multiplying the angular velocity 911 of the arm 22, which is detected by the inertial sensor 24, by the arm angular velocity scaling coefficient Kgs corresponds to the angular velocity of the driven element 602 around the rotational movement axis 604, that is, the driven element angular velocity ωl. Meanwhile, in the robot 2, the motor shaft angular velocity 913 obtained by time-differentiating the motor shaft position 902 detected by the position detector 233 corresponds to the angular velocity of the driving element 601 around the rotational movement axis 604, that is, the driving element angular velocity ωm. Further, a driving torque for the driving element 601 to rotationally move the driven element 602 acts on the spring element 603. Therefore, the spring element 603 is twisted. The deflection angular velocity ωd, which is the velocity at which the spring element 603 is twisted, can be obtained by subtracting the driving element angular velocity ωm of the driving element 601 from the driven element angular velocity ωl of the driven element 602, as shown in Equation (1) below.

$$ω d = ω l - ω m \qquad ( 1 )$$

Here, when the vibration of the driven element 602 caused by the twisting of the spring element 603 is defined as “deflection vibration”, the main cause of the vibration of the arm 22 is this “deflection vibration”. Therefore, by damping the deflection vibration, the vibration of the arm 22 can be effectively suppressed, and an excellent vibration suppression effect can be exhibited. The deflection angular velocity feedback 915 generated by the deflection angular velocity feedback generation unit 35 has an effect of damping such deflection vibration, and the damping rate of the deflection vibration is adjusted by changing the deflection angular velocity feedback gain Kgp according to the angular velocity of the arm 22.

Next, the deflection angular velocity feedback gain Kgp will be described in detail. The deflection angular velocity feedback gain Kgp is obtained by multiplying the deflection angular velocity feedback base gain Kgpb, which is a feedback base gain, by the deflection angular velocity feedback gain coefficient Kgpc, which is a feedback gain coefficient. That is, the deflection angular velocity feedback gain Kgp is represented by Equation (2) below.

$$Kgp = Kgpc \times Kgpb \qquad ( 2 )$$

Among these, the deflection angular velocity feedback base gain Kgpb is adjusted in accordance with the load 29 or the orientation of the arm 22 and is kept constant in the present embodiment. On the other hand, the deflection angular velocity feedback gain coefficient Kgpc is changed according to a rotation direction of the arm 22, that is, the angular velocity around the rotational movement axis J. As described above, with the method of changing the deflection angular velocity feedback gain coefficient Kgpc while keeping the deflection angular velocity feedback base gain Kgpb constant, the deflection angular velocity feedback gain Kgp is easily adjusted. Hereinafter, the timing of changing the deflection angular velocity feedback gain coefficient Kgpc will be described in detail.

FIG. 5 illustrates changes in the angular acceleration command Aref, the driving element angular velocity ωm, the driven element angular velocity ωl, and the deflection angular velocity ωd during the point-to-point (PTP) operation of the arm 22. For convenience of description, the deflection angular velocity ωd is shown on an enlarged scale relative to the driven element angular velocity ωl and the driving element angular velocity ωm.

As illustrated in FIG. 5, the angular acceleration command Aref changes at an angular acceleration increase start point N1s and an angular acceleration increase end point N1e at the start of acceleration, at an angular acceleration decrease start point N2s and an angular acceleration decrease end point N2e at the end of acceleration, at an angular acceleration increase start point N3s and an angular acceleration increase end point N3e at the start of deceleration, and at an angular acceleration decrease start point N4s and an angular acceleration decrease end point N4e at the end of deceleration. In addition, there is a constant velocity section between the angular acceleration decrease end point N2e and the angular acceleration increase start point N3s.

The vibration of the deflection angular velocity ωd (hereinafter, also referred to as “deflection vibration”) increases with angular acceleration change points at which the angular acceleration command Aref changes, that is, the angular acceleration increase start point N1s, the angular acceleration increase end point N1e, the angular acceleration decrease start point N2s, the angular acceleration decrease end point N2e, the angular acceleration increase start point N3s, the angular acceleration increase end point N3e, the angular acceleration decrease start point N4s, and the angular acceleration decrease end point N4e, as starting points. This is a phenomenon that occurs because the driving torque for accelerating and decelerating the driven element 602 is transmitted to the driving element 601 via the spring element 603, causing the spring element 603 to be twisted at the above-described eight points.

In that respect, in the robot system 1, the deflection angular velocity feedback gain Kgp is increased at a timing determined based on each of the above-described eight points N1s, N1e, N2s, N2e, N3s, N3e, N4s, and N4e at which the deflection vibration increases, thereby reducing the vibration of the driven element 602, that is, the arm 22.

Specifically, the deflection angular velocity feedback gain Kgp is increased with a first timing T1 determined based on the angular acceleration increase start point N1s, a second timing T2 determined based on the angular acceleration increase end point N1e, a third timing T3 determined based on the angular acceleration decrease start point N2s, a fourth timing T4 determined based on the angular acceleration decrease end point N2e, a fifth timing T5 determined based on the angular acceleration increase start point N3s, a sixth timing T6 determined based on the angular acceleration increase end point N3e, a seventh timing T7 determined based on the angular acceleration decrease start point N4s, and an eighth timing T8 determined based on the angular acceleration decrease end point N4e, as the starting points, thereby reducing the vibration of the arm 22.

In the related art, although the deflection angular velocity feedback gain Kgp is adjusted according to the orientation of the robot 2 or the magnitude of the load 29, the deflection angular velocity feedback gain Kgp is not adjusted according to the angular velocity of the arm 22 as in the present embodiment.

In the present embodiment, the first timing T1 is set at the same time point as the angular acceleration increase start point N1s, the second timing T2 is set at the same time point as the angular acceleration increase end point N1e, the third timing T3 is set at the same time point as the angular acceleration decrease start point N2s, the fourth timing T4 is set at the same time point as the angular acceleration decrease end point N2e, the fifth timing T5 is set at the same time point as the angular acceleration increase start point N3s, the sixth timing T6 is set at the same time point as the angular acceleration increase end point N3e, the seventh timing T7 is set at the same time point as the angular acceleration decrease start point N4s, and the eighth timing T8 is set at the same time point as the angular acceleration decrease end point N4e. As a result, the deflection angular velocity feedback gain Kgp can be increased without delay for each of the angular acceleration change points: the angular acceleration increase start point N1s, the angular acceleration increase end point Ne, the angular acceleration decrease start point N2s, the angular acceleration decrease end point N2e, the angular acceleration increase start point N3s, the angular acceleration increase end point N3e, the angular acceleration decrease start point N4s, and the angular acceleration decrease end point N4e, thereby obtaining a higher vibration suppression effect.

However, the present disclosure is not limited thereto, and for example, the first timing T1 may be a time point that is later by a predetermined time Δt from the angular acceleration increase start point N1s, or may be a time point that is earlier by the predetermined time Δt from the angular acceleration increase start point N1s. The same applies to the second, third, fourth, fifth, sixth, seventh, and eighth timings T2, T3, T4, T5, T6, T7, and T8 other than the first timing T1. In addition, the predetermined time Δt may be different between two or more timings optionally selected from the first, second, third, fourth, fifth, sixth, seventh, and eighth timings T1, T2, T3, T4, T5, T6, T7, and T8.

Hereinafter, for convenience of description, the first timing T1 will be described as the angular acceleration increase start point N1s, the second timing T2 will be described as the angular acceleration increase end point N1e, the third timing T3 will be described as the angular acceleration decrease start point N2s, the fourth timing T4 will be described as the angular acceleration decrease end point N2e, the fifth timing T5 will be described as the angular acceleration increase start point N3s, the sixth timing T6 will be described as the angular acceleration increase end point N3e, the seventh timing T7 will be described as the angular acceleration decrease start point N4s, and the eighth timing T8 will be described as the angular acceleration decrease end point N4e.

Here, as destabilization factors of control that may occur by increasing the deflection angular velocity feedback gain Kgp, for example, (A) physical control destabilization due to elements constituting a drive system, and (B) decreased control stability due to wrap-around of vibrations in directions different from a rotational movement direction are considered. The destabilization factor (A) refers to destabilization of control of the deflection angular velocity feedback determined by the motor shaft side inertial moment Jm, the load side inertial moment Jl, and the spring constant Ks in the two-inertia system model 600. Meanwhile, the destabilization factor (B) refers to destabilization of control of the deflection angular velocity feedback occurring when the arm 22 vibrates in the directions different from the rotational movement direction, particularly in the vertical direction, because of elastic deformation of each element constituting the robot 2, the inertial sensor 24 detects the vibration (hereinafter, also referred to as “vibration in a non-rotational movement direction”) as noise, and the controller 30 uses the noise in the control. The vibration in the non-rotational movement direction occurs due to the wrap-around of the deflection vibration in the rotational movement direction. Therefore, the vibration in the non-rotational movement direction increases with a delay relative to the deflection vibration in the rotational movement direction.

In that respect, in the robot system 1, by utilizing the characteristic that the vibration in the non-rotational movement direction increases with a delay relative to the deflection vibration in the rotational movement direction, the deflection angular velocity feedback gain Kgp is temporarily increased with the above-described eight angular acceleration change points at which the deflection vibration in the rotational movement direction increases, that is, the angular acceleration increase start point N1s, the angular acceleration increase end point N1e, the angular acceleration decrease start point N2s, the angular acceleration decrease end point N2e, the angular acceleration increase start point N3s, the angular acceleration increase end point N3e, the angular acceleration decrease start point N4s, and the angular acceleration decrease end point N4e, as the starting points to damp the deflection vibration in the rotational movement direction, thereby suppressing the destabilization of control due to the amplification of the vibration in the non-rotational movement direction. As described above, by temporarily increasing the deflection angular velocity feedback gain Kgp, the deflection angular velocity feedback gain Kgp can be decreased again when the vibration in the non-rotational movement direction increases, thereby reducing, or preferably eliminating, the influence of the destabilization factor (B).

In the related art, because of the destabilization factor (B), the deflection angular velocity feedback gain Kgp cannot be increased to a limit value (maximum value) of the destabilization factor (A). On the other hand, with the control method of the present embodiment as described above, the influence of the destabilization factor (B) is reduced as described above, so that the deflection angular velocity feedback gain Kgp can be increased to the limit value of the destabilization factor (A). Therefore, the deflection angular velocity feedback gain Kgp can be set to be higher than that in the related art without causing the destabilization of control, and the vibration suppression effect of the arm 22 can be enhanced.

FIG. 6 is a timing chart illustrating an example of processing of adjusting the deflection angular velocity feedback gain Kgp with the above-described eight points which are change points of the angular acceleration command Aref, that is, the angular acceleration increase start point N1s, the angular acceleration increase end point N1e, the angular acceleration decrease start point N2s, the angular acceleration decrease end point N2e, the angular acceleration increase start point N3s, the angular acceleration increase end point N3e, the angular acceleration decrease start point N4s, and the angular acceleration decrease end point N4e, as the starting points. FIG. 6 illustrates changes in the angular acceleration command Aref, a velocity command Vref, and the deflection angular velocity feedback gain coefficient Kgpc.

In the illustrated example, the deflection angular velocity feedback gain coefficient Kgpc is increased from 1, which is the reference value, to 3 for time dt (seconds) with all the points: the angular acceleration increase start point N1s, the angular acceleration increase end point N1e, the angular acceleration decrease start point N2s, the angular acceleration decrease end point N2e, the angular acceleration increase start point N3s, the angular acceleration increase end point N3e, the angular acceleration decrease start point N4s, and the angular acceleration decrease end point N4e, as the starting points. The deflection angular velocity feedback gain coefficient Kgpc is increased from 1 to 3, and then the deflection angular velocity feedback gain coefficient Kgpc is decreased from 3 to 1, that is, to the reference value, after the elapse of time dt. Therefore, the controller 30 controls the drive of the motor 232 by using the deflection angular velocity feedback gain coefficient Kgpc=3 until the deflection angular velocity feedback gain coefficient Kgpc is increased from 1 to 3 and then decreased to 1 again, and controls the drive of the motor 232 by using the deflection angular velocity feedback gain coefficient Kgpc=1 at other times. As described above, by increasing and decreasing the deflection angular velocity feedback gain coefficient Kgpc with respect to the reference value of 1, the deflection angular velocity feedback gain coefficient Kgpc is easily adjusted.

The deflection angular velocity feedback gain Kgp is obtained by multiplying the deflection angular velocity feedback base gain Kgpb by the deflection angular velocity feedback gain coefficient Kgpc as shown in Equation (2) above. Therefore, while the deflection angular velocity feedback gain coefficient Kgpc is increased to 3, the deflection angular velocity feedback gain Kgp is increased by three times. By increasing the deflection angular velocity feedback gain Kgp by three times, the effect of damping the deflection vibration is increased, and it is possible to reduce the deflection vibration that increases during operation with each of the angular acceleration change points: the angular acceleration increase start point N1s, the angular acceleration increase end point N1e, the angular acceleration decrease start point N2s, the angular acceleration decrease end point N2e, the angular acceleration increase start point N3s, and the angular acceleration increase end point N3e, as the starting points, and the residual vibration that increases during stopping with each of the angular acceleration change points, that is, the angular acceleration decrease start point N4s and the angular acceleration decrease end point N4e, as the starting points.

The adjustment of the deflection angular velocity feedback gain coefficient Kgpc at the angular acceleration increase start point N1s and the angular acceleration increase end point N1e has the effect of reducing the deflection vibration of the arm 22 during the acceleration operation. In addition, the adjustment of the deflection angular velocity feedback gain coefficient Kgpc at the angular acceleration decrease start point N2s and the angular acceleration decrease end point N2e has the effect of reducing the deflection vibration of the arm 22 during the constant velocity operation. Further, the adjustment of the deflection angular velocity feedback gain coefficient Kgpc at the angular acceleration increase start point N3s and the angular acceleration increase end point N3e has the effect of reducing the deflection vibration of the arm 22 during the deceleration operation. Furthermore, the adjustment of the deflection angular velocity feedback gain coefficient Kgpc at the angular acceleration decrease start point N4s and the angular acceleration decrease end point N4e has the effect of reducing the residual vibration of the arm 22.

In the illustrated example, the deflection angular velocity feedback gain coefficient Kgpc is increased from 1 to 3 with all the points: the angular acceleration increase start point N1s, the angular acceleration increase end point N1e, the angular acceleration decrease start point N2s, the angular acceleration decrease end point N2e, the angular acceleration increase start point N3s, the angular acceleration increase end point N3e, the angular acceleration decrease start point N4s, and the angular acceleration decrease end point N4e, as the starting points, but the present disclosure is not limited thereto, and the deflection angular velocity feedback gain coefficient Kgpc need only be increased from 1 to 3 with at least one of the eight points as the starting point. Consequently, at least the vibration that increases with the point as the starting point can be effectively suppressed. In addition, in the illustrated example, the deflection angular velocity feedback gain coefficient Kgpc is increased to 3, but the value of the deflection angular velocity feedback gain coefficient Kgpc is not particularly limited.

When time dt during which the deflection angular velocity feedback gain coefficient Kgpc is increased to 3 is too long, the vibration in the non-rotational movement direction may increase during the time, which may lead to the destabilization of control of the deflection angular velocity feedback. On the other hand, when time dt is too short, the above-described vibration suppression effect may not be sufficiently exhibited. Therefore, there is a need to appropriately set time dt. Time dt is not particularly limited and varies depending on the configuration of the robot 2 and the operation of the arm 22. However, for example, time dt is preferably approximately 0.1 seconds or more and 2 seconds or less, which corresponds to 0.1 times to 2 times the natural vibration period of the deflection vibration. In addition, in the present embodiment, time dt is equal at all the points: the angular acceleration increase start point N1s, the angular acceleration increase end point N1e, the angular acceleration decrease start point N2s, the angular acceleration decrease end point N2e, the angular acceleration increase start point N3s, the angular acceleration increase end point N3e, the angular acceleration decrease start point N4s, and the angular acceleration decrease end point N4e. This simplifies the processing of adjusting the deflection angular velocity feedback gain coefficient Kgpc.

FIG. 7 is a graph illustrating the residual vibration suppression effect of the arm 22 and compares the residual vibration in the rotation direction occurring at the tip end portion of the arm 22 between A, where the deflection angular velocity feedback gain Kgp is kept constant, and B, where the deflection angular velocity feedback gain Kgp is changed in synchronization with the angular acceleration change as in the present embodiment. When the deflection angular velocity feedback gain Kgp is kept constant, overshoot occurs beyond the target position, and then the residual vibration is damped, and the operation stops at the target position. On the other hand, when the deflection angular velocity feedback gain Kgp is changed in synchronization with the angular acceleration change as in the present embodiment, the operation promptly stops at the target position with almost no overshoot or residual vibration. Therefore, it can be seen that an excellent vibration suppression effect is exhibited.

For example, when a part assembly work or the like is performed by using the robot 2, an excessive force is applied to a workpiece due to the overshoot, thereby leading to damage to the workpiece or variations in the position of the incorporated workpiece, which causes a decrease in product quality. In addition, the residual vibration prolongs a cycle time of the assembly work, which causes a decrease in the productivity. From this, with the robot system 1 that does not cause overshoot, a high-quality product can be produced with high productivity.

In the present embodiment, the angular acceleration increase start point N1s, the angular acceleration increase end point N1e, the angular acceleration decrease start point N2s, the angular acceleration decrease end point N2e, the angular acceleration increase start point N3s, the angular acceleration increase end point N3e, the angular acceleration decrease start point N4s, and the angular acceleration decrease end point N4e are detected based on the angular acceleration command Aref which is the position command of the arm 22. With such a method, each of the points N1s, N1e, N2s, N2e, N3s, N3e, N4s, and N4e can be detected more accurately. Therefore, a higher vibration suppression effect can be exhibited with excellent reproducibility.

However, the method of detecting each of the points N1s, N1e, N2s, N2e, N3s, N3e, N4s, and N4e is not particularly limited. For example, each of the points N1s, N1e, N2s, N2e, N3s, N3e, N4s, and N4e may be detected by using the acceleration obtained by second-order differentiating the motor shaft position 902 detected by the position detector 233. However, the acceleration obtained by second-order differentiating the motor shaft position 902 has a significant ripple (pulsating alternating current components), which may result in inferior detection accuracy for each of the points N1s, N1e, N2s, N2e, N3s, N3e, N4s, and N4e compared to detection based on the angular acceleration command Aref. Therefore, it is more preferable to detect each of the points N1s, N1e, N2s, N2e, N3s, N3e, N4s, and N4e based on the angular acceleration command Aref.

From the above description, as illustrated in FIG. 8, it can be said that the control method of the robot 2 as described above includes an inertial information reception step S1 of receiving the angular velocity 911, which is the output signal from the inertial sensor 24 that measures the operation of the arm 22, a first feedback gain adjustment step S2 of performing adjustment to increase the deflection angular velocity feedback gain Kgp to be multiplied by the angular velocity 911 or the signal generated from the angular velocity 911, in the present embodiment, the deflection angular velocity 914 generated from the angular velocity 911, according to the change in the angular velocity of the arm 22, a drive control step S3 of controlling the drive of the arm 22 by using the deflection angular velocity feedback gain Kgp increased in the first feedback gain adjustment step S2, and a second feedback gain adjustment step S4 of performing adjustment to decrease the deflection angular velocity feedback gain Kgp after the elapse of time dt from the first feedback gain adjustment step S2. With such a control method, the deflection angular velocity feedback gain Kgp can be increased to the limit value of the destabilization factor (A) without causing the destabilization of control. Therefore, the deflection angular velocity feedback gain Kgp can be set to be higher than that in the related art, and the vibration of the arm 22 can be more effectively suppressed.

The robot system 1 is described above. The control method of the robot 2 used in such a robot system 1 includes, as described above, the inertial information reception step S1 of receiving the angular velocity 911 included in the output signal from the inertial sensor 24 that measures the operation of the arm 22, the first feedback gain adjustment step S2 of performing adjustment to increase the deflection angular velocity feedback gain Kgp, which is the feedback gain to be multiplied by the angular velocity 911 or the signal generated from the angular velocity 911, in the present embodiment, the deflection angular velocity 914 generated from the angular velocity 911, according to the change in the operation of the arm 22, the drive control step S3 of controlling the drive of the arm 22 by using the deflection angular velocity feedback gain Kgp increased in the first feedback gain adjustment step S2, and the second feedback gain adjustment step S4 of performing adjustment to decrease the deflection angular velocity feedback gain Kgp after the elapse of time dt, which is the predetermined time, from the first feedback gain adjustment step S2. With such a control method, the deflection angular velocity feedback gain Kgp can be increased to the limit value of the destabilization factor (A) without causing the destabilization of control. Therefore, the deflection angular velocity feedback gain Kgp can be set to be higher than that in the related art, and the vibration of the arm 22 can be more effectively suppressed.

In addition, as described above, in the control method of the robot 2, in the first feedback gain adjustment step S2, the deflection angular velocity feedback gain coefficient Kgpc is changed from 1, which is the reference value, to a value higher than the reference value, and in the second feedback gain adjustment step S4, the deflection angular velocity feedback gain coefficient Kgpc is returned to 1, which is the reference value. As a result, the deflection angular velocity feedback gain Kgp is easily adjusted.

Further, as described above, the output signal from the inertial sensor 24 includes the inertial information which is the information regarding the inertia generated in the arm 22 by the operation of the arm 22, that is, the angular velocity. In the control method of the robot 2, the first feedback gain adjustment step S2 is performed at at least one of the angular acceleration increase start point N1s which is the first timing T1 at which the increase in the angular velocity starts at the start of acceleration of the arm 22, the angular acceleration increase end point N1e which is the second timing T2 at which the increase in the angular velocity ends at the start of acceleration of the arm 22, the angular acceleration decrease start point N2s which is the third timing T3 at which the decrease in the angular velocity starts at the end of acceleration of the arm 22, the angular acceleration decrease end point N2e which is the fourth timing T4 at which the decrease in the angular velocity ends at the end of acceleration of the arm 22, the angular acceleration increase start point N3s which is the fifth timing T5 at which the increase in the angular velocity starts at the start of deceleration of the arm 22, the angular acceleration increase end point N3e which is the sixth timing T6 at which the increase in the angular velocity ends at the start of deceleration of the arm 22, the angular acceleration decrease start point N4s which is the seventh timing T7 at which the decrease in the angular velocity starts at the end of deceleration of the arm 22, and the angular acceleration decrease end point N4e which is the eighth timing T8 at which the decrease in the angular velocity ends at the end of deceleration of the arm 22. As a result, the vibration that increases with each of the points as the starting point can be effectively reduced.

Additionally, as described above, in the control method of the robot 2, the deflection angular velocity feedback gain Kgp is obtained by multiplying the deflection angular velocity feedback base gain Kgpb, which is the feedback base gain serving as the reference of the deflection angular velocity feedback gain Kgp, by the deflection angular velocity feedback gain coefficient Kgpc, which is the feedback gain coefficient. In the first feedback gain adjustment step S2 and the second feedback gain adjustment step S4, the deflection angular velocity feedback gain Kgp is adjusted by changing the deflection angular velocity feedback gain coefficient Kgpc. As a result, the deflection angular velocity feedback gain Kgp is easily adjusted.

Further, as described above, in the control method of the robot 2, the change in the angular velocity of the arm 22 is detected based on the angular acceleration command Aref, which is the position command for the arm 22. With such a method, the angular acceleration increase start point N1s, the angular acceleration increase end point N1e, the angular acceleration decrease start point N2s, the angular acceleration decrease end point N2e, the angular acceleration increase start point N3s, the angular acceleration increase end point N3e, the angular acceleration decrease start point N4s, and the angular acceleration decrease end point N4e can be detected more accurately. Therefore, a higher vibration suppression effect can be exhibited with excellent reproducibility.

Moreover, as described above, the robot system 1 includes the base 21, the arm 22 that is driven with respect to the base 21, the inertial sensor 24 that detects the angular velocity, which is the operation of the arm 22, and the controller 30 that controls the drive of the arm 22. The controller 30 receives the angular velocity 911 which is the output signal from the inertial sensor 24, performs adjustment to increase the deflection angular velocity feedback gain Kgp, which is the feedback gain to be multiplied by the angular velocity 911 or the signal generated from the angular velocity 911, in the present embodiment, the deflection angular velocity 914 generated from the angular velocity 911, according to the change in the angular velocity of the arm 22, controls the drive of the arm 22 by using the deflection angular velocity feedback gain Kgp after the adjustment, and performs adjustment to decrease the deflection angular velocity feedback gain Kgp after the elapse of time dt, which is the predetermined time, from the increase of the deflection angular velocity feedback gain Kgp. With such a configuration, the deflection angular velocity feedback gain Kgp can be increased to the limit value of the destabilization factor (A) without causing the destabilization of control. Therefore, the deflection angular velocity feedback gain Kgp can be set to be higher than that in the related art, and the vibration of the arm 22 can be more effectively suppressed.

In addition, as described above, the robot system 1 includes the motor 232 that rotationally moves the arm 22 around the rotational movement axis J with respect to the base 21, and the position detector 233 that detects the rotation angle of the motor 232. Further, the inertial sensor 24 detects the angular velocity of the arm 22 around the rotational movement axis J. Furthermore, the controller 30 obtains the deflection angular velocity 914 based on the motor shaft equivalent arm angular velocity 912, which is the angular velocity of the arm 22 detected by the inertial sensor 24, and the motor shaft angular velocity 913, which is the angular velocity of the motor 232 detected by the position detector 233, and multiplies the deflection angular velocity 914 by the deflection angular velocity feedback gain Kgp. By using the deflection angular velocity feedback 915 obtained in this manner, the vibration suppression effect of the arm 22 can be enhanced.

### Second Embodiment

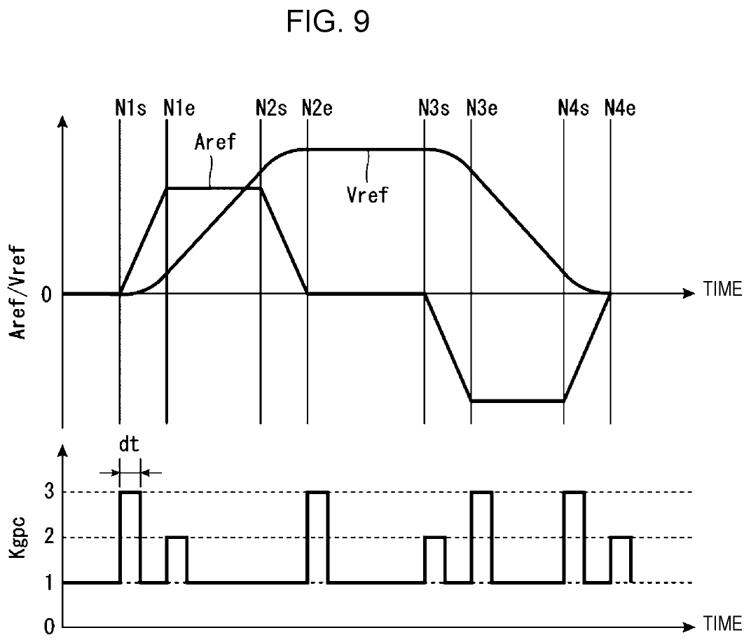

FIG. 9 is a timing chart illustrating an example of processing of adjusting the deflection angular velocity feedback gain Kgp performed in a robot system according to a second embodiment.

The present embodiment is the same as the first embodiment described above except that the processing of adjusting the deflection angular velocity feedback gain Kgp is different. In the following description, the present embodiment will be described with a focus on differences from the first embodiment described above, and the description of the same matters will not be repeated. In addition, in the drawings of the present embodiment, the same configurations as those of the embodiment described above are denoted by the same reference numerals.

In the first feedback gain adjustment step S2 of the present embodiment, the deflection angular velocity feedback gain Kgp is adjusted to be different between any two points selected from the angular acceleration increase start point N1s, the angular acceleration increase end point N1e, the angular acceleration decrease start point N2s, the angular acceleration decrease end point N2e, the angular acceleration increase start point N3s, the angular acceleration increase end point N3e, the angular acceleration decrease start point N4s, and the angular acceleration decrease end point N4e.

In the example illustrated in FIG. 9, the deflection angular velocity feedback gain coefficient Kgpc is adjusted to 3 at the angular acceleration increase start point N1s, 2 at the angular acceleration increase end point N1e, 1 at the angular acceleration decrease start point N2s, 3 at the angular acceleration decrease end point N2e, 2 at the angular acceleration increase start point N3s, 3 at the angular acceleration increase end point N3e, 3 at the angular acceleration decrease start point N4s, and 2 at the angular acceleration decrease end point N4e. As described above, by adjusting the deflection angular velocity feedback gain coefficient Kgpc for each angular acceleration change point, the vibration of the arm 22 during the acceleration operation, the vibration during the deceleration operation, and the residual vibration after stopping can be effectively suppressed.

As described above, in the control method of the robot 2 of the present embodiment, in the first feedback gain adjustment step S2, the deflection angular velocity feedback gain Kgp is adjusted to be different between any two timings selected from the angular acceleration increase start point N1s which is the first timing T1, the angular acceleration increase end point N1e which is the second timing T2, the angular acceleration decrease start point N2s which is the third timing T3, the angular acceleration decrease end point N2e which is the fourth timing T4, the angular acceleration increase start point N3s which is the fifth timing T5, the angular acceleration increase end point N3e which is the sixth timing T6, the angular acceleration decrease start point N4s which is the seventh timing T7, and the angular acceleration decrease end point N4e which is the eighth timing T8. As described above, by adjusting the deflection angular velocity feedback gain Kgp for each angular acceleration change point, the vibration of the arm 22 during the acceleration operation, the vibration during the deceleration operation, and the residual vibration after stopping can be effectively suppressed.

Even in the second embodiment as described above, the same effect as that of the first embodiment described above can be exhibited.

### Third Embodiment

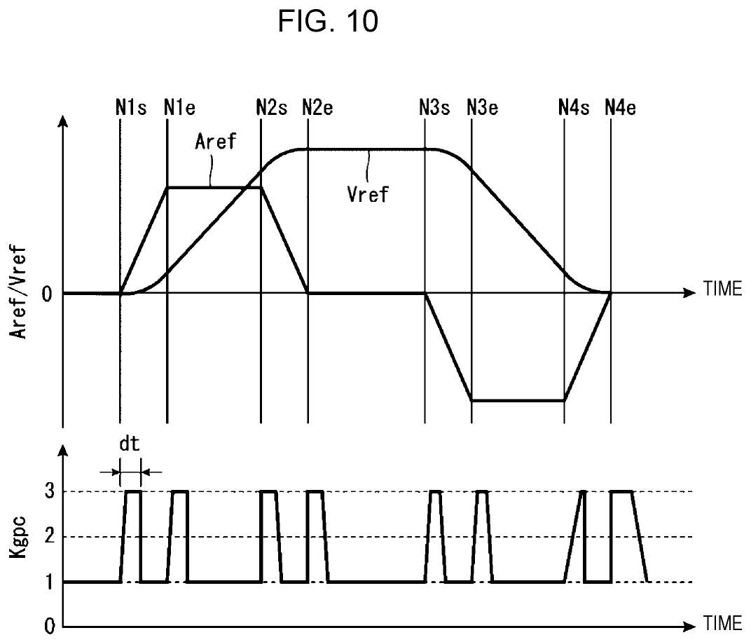

FIG. 10 is a timing chart illustrating an example of processing of adjusting the deflection angular velocity feedback gain Kgp performed in a robot system according to a third embodiment.

The present embodiment is the same as the first embodiment described above except that the processing of adjusting the deflection angular velocity feedback gain Kgp is different. In the following description, the present embodiment will be described with a focus on differences from the first embodiment described above, and the description of the same matters will not be repeated. In addition, in the drawings of the present embodiment, the same configurations as those of the embodiment described above are denoted by the same reference numerals.

In the first feedback gain adjustment step S2 of the present embodiment, the rise and fall of the deflection angular velocity feedback gain coefficient Kgpc are gradually or continuously changed for at least one of the angular acceleration increase start point N1s, the angular acceleration increase end point N1e, the angular acceleration decrease start point N2s, the angular acceleration decrease end point N2e, the angular acceleration increase start point N3s, the angular acceleration increase end point N3e, the angular acceleration decrease start point N4s, and the angular acceleration decrease end point N4e.

In the example illustrated in FIG. 10, the rise of the deflection angular velocity feedback gain coefficient Kgpc is continuously increased at the angular acceleration increase start point N1s and the angular acceleration increase end point N1e. In addition, the fall of the deflection angular velocity feedback gain coefficient Kgpc is continuously decreased at the angular acceleration decrease start point N2s and the angular acceleration decrease end point N2e. Further, the rise of the deflection angular velocity feedback gain coefficient Kgpc is continuously increased and the fall is continuously decreased, at the angular acceleration increase start point N3s and the angular acceleration increase end point N3e. Moreover, at the angular acceleration decrease start point N4s, the rise of the deflection angular velocity feedback gain coefficient Kgpc is increased continuously and at a smaller rate of change than at the angular acceleration increase start point N1s, the angular acceleration increase end point N1e, the angular acceleration increase start point N3s, and the angular acceleration increase end point N3e. Furthermore, at the angular acceleration decrease end point N4e, the fall of the deflection angular velocity feedback gain coefficient Kgpc is decreased continuously and at a smaller rate of change than at the angular acceleration decrease start point N2s, the angular acceleration decrease end point N2e, the angular acceleration increase start point N3s, and the angular acceleration increase end point N3e.

As described above, by continuously increasing the rise of the deflection angular velocity feedback gain coefficient Kgpc, the processing of increasing the deflection angular velocity feedback gain Kgp for the angular acceleration change point can be delayed. Therefore, the influence of the twisting of the spring element 603 due to the change in the angular acceleration can be suppressed, and the destabilization of control can be effectively suppressed. On the other hand, by continuously decreasing the fall of the deflection angular velocity feedback gain coefficient Kgpc, the processing of decreasing the deflection angular velocity feedback gain Kgp can be delayed, thereby prolonging the vibration suppression effect accordingly.

Even in the third embodiment as described above, the same effect as that of the first embodiment described above can be exhibited.

### Fourth Embodiment

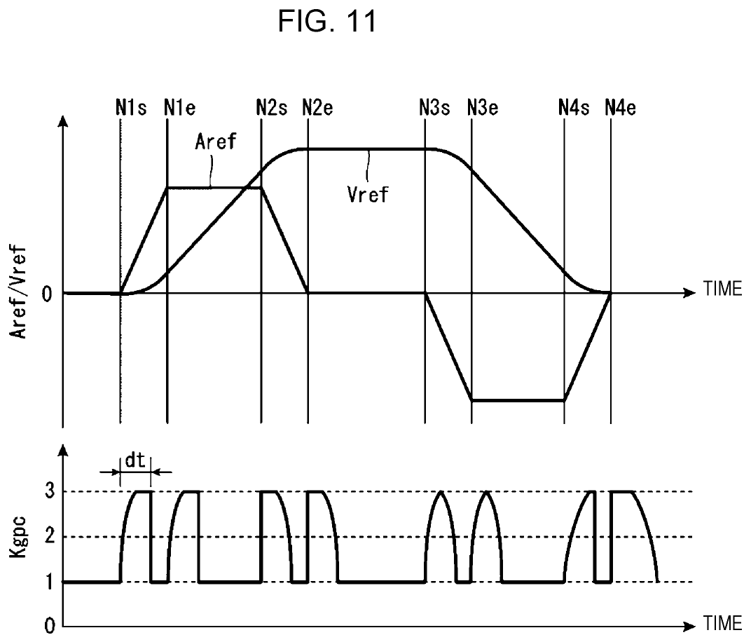

FIG. 11 is a timing chart illustrating an example of processing of adjusting the deflection angular velocity feedback gain Kgp performed in a robot system according to a fourth embodiment.

The present embodiment is the same as the first embodiment described above except that the processing of adjusting the deflection angular velocity feedback gain Kgp is different. In the following description, the present embodiment will be described with a focus on differences from the first embodiment described above, and the description of the same matters will not be repeated. In addition, in the drawings of the present embodiment, the same configurations as those of the embodiment described above are denoted by the same reference numerals.

In the third embodiment described above, the rise and fall of the deflection angular velocity feedback gain coefficient Kgpc is linearly changed. That is, the rate of change is constant. On the other hand, in the present embodiment, as illustrated in FIG. 11, the rise and fall of the deflection angular velocity feedback gain coefficient Kgpc change in a quadratic curve.

By increasing the rise of the deflection angular velocity feedback gain coefficient Kgpc in a quadratic curve, the deflection angular velocity feedback gain Kgp can be increased in a short time, thereby enhancing the vibration suppression effect. In addition, the rate of change of the deflection angular velocity feedback gain Kgp decreases with the elapse of time, so that the destabilization of control can be suppressed. On the other hand, by decreasing the fall of the deflection angular velocity feedback gain coefficient Kgpc in a quadratic curve, the processing of decreasing the deflection angular velocity feedback gain Kgp can be delayed, thereby prolonging the vibration suppression effect.

Even in the fourth embodiment as described above, the same effect as that of the first embodiment described above can be exhibited.

### Fifth Embodiment

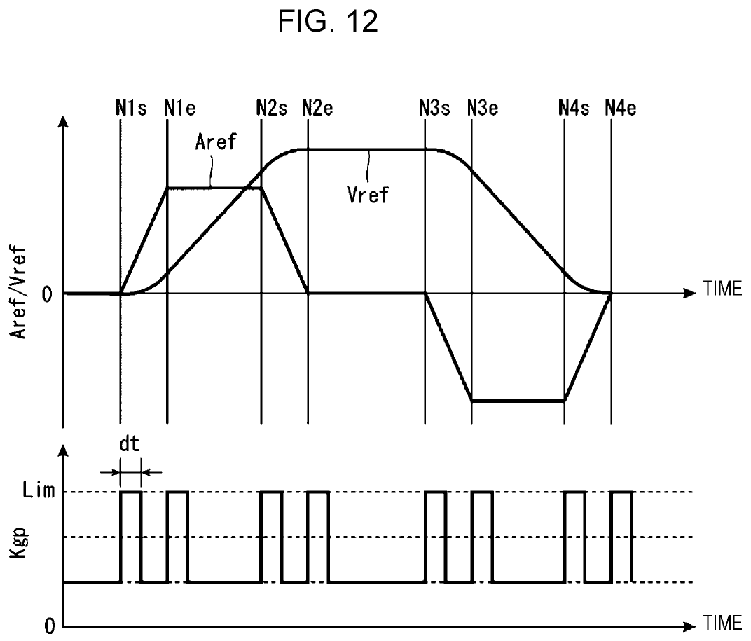

FIG. 12 is a timing chart illustrating an example of processing of adjusting the deflection angular velocity feedback gain Kgp performed in a robot system according to a fifth embodiment.

The present embodiment is the same as the first embodiment described above except that the processing of adjusting the deflection angular velocity feedback gain Kgp is different. In the following description, the present embodiment will be described with a focus on differences from the first embodiment described above, and the description of the same matters will not be repeated. In addition, in the drawings of the present embodiment, the same configurations as those of the embodiment described above are denoted by the same reference numerals.

In the present embodiment, as illustrated in FIG. 12, an upper limit Lim is set for the deflection angular velocity feedback gain Kgp, and the deflection angular velocity feedback gain Kgp is adjusted not to exceed the upper limit Lim. The adjustment method is not particularly limited and may be, for example, a method of adjusting the deflection angular velocity feedback gain coefficient Kgpc not to exceed the upper limit Lim. In addition, a method may be used in which the deflection angular velocity feedback gain coefficient Kgpc is adjusted regardless of the upper limit Lim, and when the deflection angular velocity feedback gain Kgp after the adjustment exceeds the upper limit Lim, the deflection angular velocity feedback gain Kgp is set to the upper limit Lim. As described above, by setting the upper limit Lim for the deflection angular velocity feedback gain Kgp, the destabilization of control due to the deflection angular velocity feedback gain Kgp being too high can be effectively suppressed.

Even in the fifth embodiment as described above, the same effect as that of the first embodiment described above can be exhibited.

### Sixth Embodiment

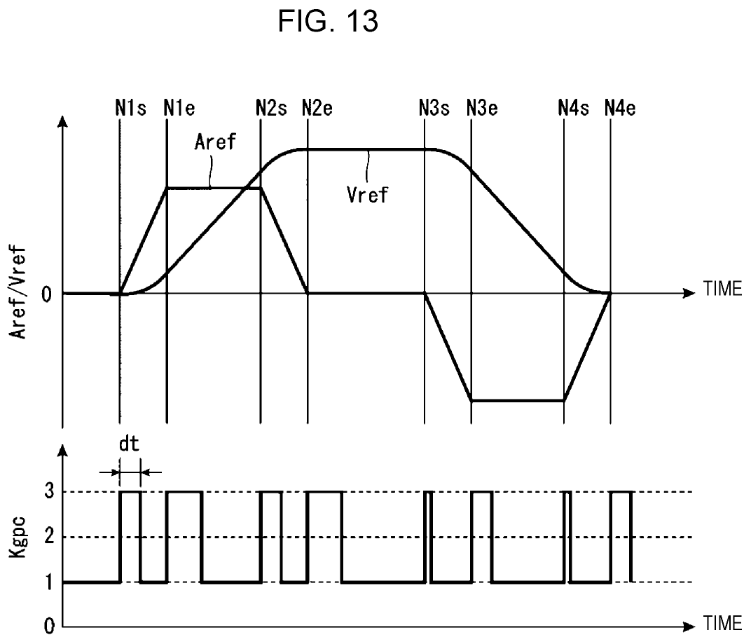

FIG. 13 is a timing chart illustrating an example of processing of adjusting the deflection angular velocity feedback gain Kgp performed in a robot system according to a sixth embodiment.

The present embodiment is the same as the first embodiment described above except that the processing of adjusting the deflection angular velocity feedback gain Kgp is different. In the following description, the present embodiment will be described with a focus on differences from the first embodiment described above, and the description of the same matters will not be repeated. In addition, in the drawings of the present embodiment, the same configurations as those of the embodiment described above are denoted by the same reference numerals.

In the first feedback gain adjustment step S2 of the present embodiment, time dt is different between any two points selected from the angular acceleration increase start point N1s, the angular acceleration increase end point N1e, the angular acceleration decrease start point N2s, the angular acceleration decrease end point N2e, the angular acceleration increase start point N3s, the angular acceleration increase end point N3e, the angular acceleration decrease start point N4s, and the angular acceleration decrease end point N4e.

In the example illustrated in FIG. 13, compared to time dt at the angular acceleration increase start point N1s, the angular acceleration decrease start point N2s, the angular acceleration increase end point N3e, and the angular acceleration decrease end point N4e, time dt at the angular acceleration increase end point N1e and the angular acceleration decrease end point N2e is longer, and conversely, time dt at the angular acceleration increase start point N3s and the angular acceleration decrease start point N4s is shorter. Since increasing time dt prolongs a state in which the deflection angular velocity feedback gain Kgp is high, the vibration suppression effect can be enhanced. On the other hand, by shortening time dt, the wrap-around of the vibration in the non-rotational movement direction as described above can be suppressed, and the destabilization of control can be effectively suppressed. Therefore, by setting time dt for each angular acceleration change point, a balance can be struck between the vibration suppression effect and the destabilization of control at each angular acceleration change point.

As described above, in the control method of the robot 2 of the present embodiment, in the first feedback gain adjustment step S2, time dt as the predetermined time is different between any two timings selected from the angular acceleration increase start point N1s which is the first timing T1, the angular acceleration increase end point N1e which is the second timing T2, the angular acceleration decrease start point N2s which is the third timing T3, the angular acceleration decrease end point N2e which is the fourth timing T4, the angular acceleration increase start point N3s which is the fifth timing T5, the angular acceleration increase end point N3e which is the sixth timing T6, the angular acceleration decrease start point N4s which is the seventh timing T7, and the angular acceleration decrease end point N4e which is the eighth timing T8. With such a method, a balance can be struck between the vibration suppression effect and the destabilization of control at each timing.

Even in the sixth embodiment as described above, the same effect as that of the first embodiment described above can be exhibited.

### Seventh Embodiment

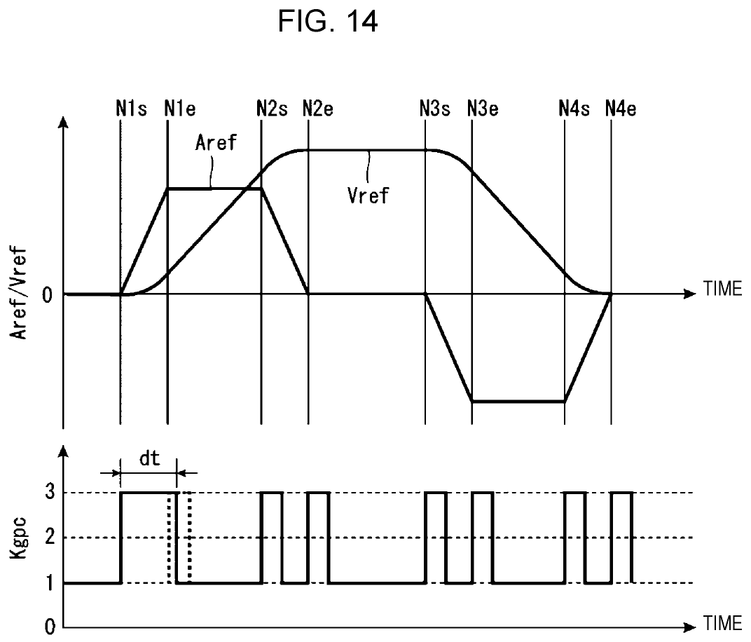

FIG. 14 is a timing chart illustrating an example of processing of adjusting the deflection angular velocity feedback gain Kgp performed in a robot system according to a seventh embodiment.

The present embodiment is the same as the first embodiment described above except that the processing of adjusting the deflection angular velocity feedback gain Kgp is different. In the following description, the present embodiment will be described with a focus on differences from the first embodiment described above, and the description of the same matters will not be repeated. In addition, in the drawings of the present embodiment, the same configurations as those of the embodiment described above are denoted by the same reference numerals.

In the present embodiment, as illustrated in FIG. 14, when the adjustment of the deflection angular velocity feedback gain coefficient Kgpc with the angular acceleration increase start point N1s as the starting point is continued until the angular acceleration increase end point N1e, the adjustment of the deflection angular velocity feedback gain coefficient Kgpc with the angular acceleration increase end point N1e as the starting point is canceled. That is, when the adjustment of the deflection angular velocity feedback gain coefficient Kgpc with a certain angular acceleration change point as the starting point is continued until the next angular acceleration change point, the adjustment of the deflection angular velocity feedback gain coefficient Kgpc with the next angular acceleration change point as the starting point is canceled. With such processing, the processing of adjusting the deflection angular velocity feedback gain coefficient Kgpc can be continuously performed, thereby suppressing prolongation of the time for increasing the deflection angular velocity feedback gain Kgp. Therefore, the destabilization of control can be effectively suppressed.

Even in the seventh embodiment as described above, the same effect as that of the first embodiment described above can be exhibited.

### Eighth Embodiment

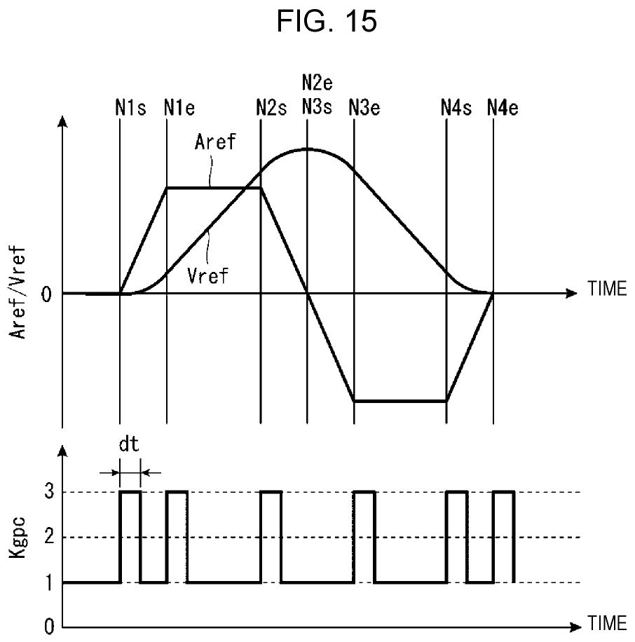

FIG. 15 is a timing chart illustrating an example of processing of adjusting the deflection angular velocity feedback gain Kgp performed in a robot system according to an eighth embodiment.

The present embodiment is the same as the first embodiment described above except that the processing of adjusting the deflection angular velocity feedback gain Kgp is different. In the following description, the present embodiment will be described with a focus on differences from the first embodiment described above, and the description of the same matters will not be repeated. In addition, in the drawings of the present embodiment, the same configurations as those of the embodiment described above are denoted by the same reference numerals.

In FIG. 15, there is no section in which the arm 22 operates at a constant velocity. In this case, a point at which the velocity command Vref is turned from an increase to a decrease corresponds to the angular acceleration decrease end point N2e and the angular acceleration increase start point N3s. In the present embodiment, the adjustment of the deflection angular velocity feedback gain coefficient Kgpc with the two points N2e and N3s as the starting points is not performed. This is because there is no increase in the deflection vibration due to no change in the angular acceleration at the points N2e and N3s, resulting in a low vibration suppression effect achieved by adjusting the deflection angular velocity feedback gain Kgp. As described above, by not adjusting the deflection angular velocity feedback gain coefficient Kgpc at a point at which the vibration suppression effect is low, the destabilization of control can be suppressed.

Even in the eighth embodiment as described above, the same effect as that of the first embodiment described above can be exhibited.

### Ninth Embodiment

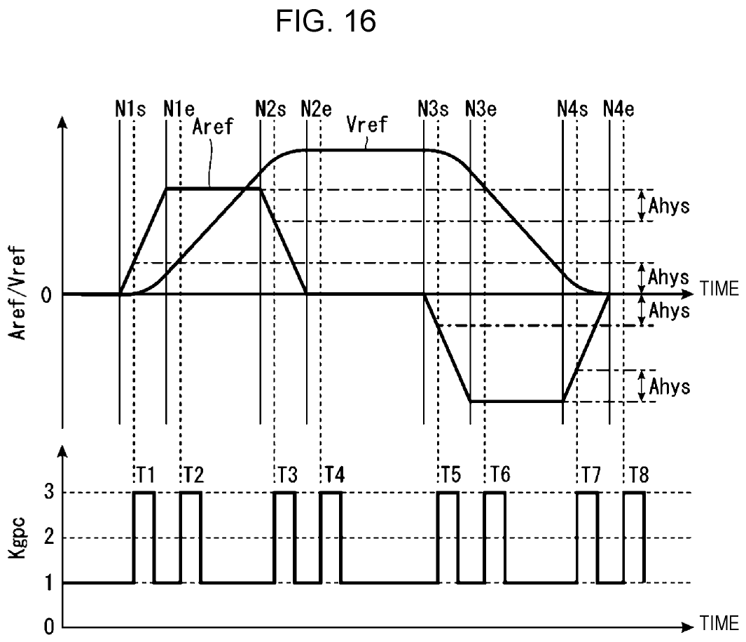

FIG. 16 is a timing chart illustrating an example of processing of adjusting the deflection angular velocity feedback gain Kgp performed in a robot system according to a ninth embodiment.

The present embodiment is the same as the first embodiment described above except that the processing of adjusting the deflection angular velocity feedback gain Kgp is different. In the following description, the present embodiment will be described with a focus on differences from the first embodiment described above, and the description of the same matters will not be repeated. In addition, in the drawings of the present embodiment, the same configurations as those of the embodiment described above are denoted by the same reference numerals.

In the present embodiment, the deflection angular velocity feedback gain coefficient Kgpc is adjusted with a point at which the angular acceleration of the arm 22 exceeds a predetermined threshold value, for example, ±Ahys, as the starting point. In the example illustrated in FIG. 16, the adjustment to increase the deflection angular velocity feedback gain coefficient Kgpc is performed with a point at which the angular acceleration starts to increase from a constant state and the angular acceleration exceeds the threshold value, that is, the time points (the first timing T1, the third timing T3, the fifth timing T5, and the seventh timing T7) slightly delayed from the angular acceleration increase start point N1s, the angular acceleration decrease start point N2s, the angular acceleration increase start point N3s, and the angular acceleration decrease start point N4s, as the starting points. As a result, the vibration of the arm 22 can be more effectively suppressed.

In such processing, since the angular acceleration change point is detected, there is a risk of erroneously detecting the angular acceleration change point due to noise included in the angular acceleration. In that respect, by providing a hysteresis characteristic of ±Ahys for the determination of the angular acceleration change point, the erroneous detection of the angular acceleration change point can be suppressed.

In addition, in the present embodiment, the deflection angular velocity feedback gain coefficient Kgpc is adjusted with a point at which the angular acceleration of the arm 22 transitions from a changing state to a constant state as the starting point. In the example illustrated in FIG. 16, the adjustment to increase the deflection angular velocity feedback gain coefficient Kgpc is performed with a point at which the angular acceleration transitions from a changing state to a constant state, that is, the time points (the second timing T2, the fourth timing T4, the sixth timing T6, and the eighth timing T8) slightly delayed from the angular acceleration increase end point N1e, the angular acceleration decrease end point N2e, the angular acceleration increase end point N3e, and the angular acceleration decrease end point N4e, as the starting points.

As described above, in the control method of the robot 2 of the present embodiment, the first timing T1, the third timing T3, the fifth timing T5, and the seventh timing T7 are timings at which the angular acceleration, which is the inertial information, exceeds the threshold value. As a result, the vibration of the arm 22 can be more effectively suppressed.

Even in the ninth embodiment as described above, the same effect as that of the first embodiment described above can be exhibited.

### Tenth Embodiment

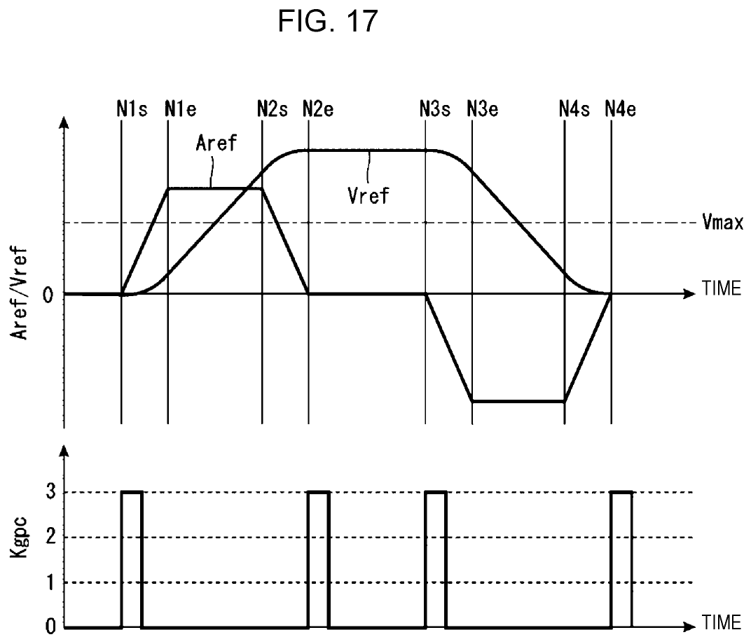

FIG. 17 is a timing chart illustrating an example of processing of adjusting the deflection angular velocity feedback gain Kgp performed in a robot system according to a tenth embodiment.

The present embodiment is the same as the first embodiment described above except that the processing of adjusting the deflection angular velocity feedback gain Kgp is different. In the following description, the present embodiment will be described with a focus on differences from the first embodiment described above, and the description of the same matters will not be repeated. In addition, in the drawings of the present embodiment, the same configurations as those of the embodiment described above are denoted by the same reference numerals.

In the present embodiment, when the adjustment to increase the deflection angular velocity feedback gain Kgp is not performed, the deflection angular velocity feedback gain coefficient Kgpc is set to zero. That is, the reference value of the deflection angular velocity feedback gain coefficient Kgpc is set to zero. In the example illustrated in FIG. 17, an angular velocity detection range of the inertial sensor 24 is limited to Vmax or less. For the angular acceleration increase start point N1s, the angular acceleration decrease end point N2e, the angular acceleration increase start point N3s, and the angular acceleration decrease end point N4e, at which the angular velocity is Vmax or less, the adjustment to increase the deflection angular velocity feedback gain coefficient Kgpc with each of the points as the starting point is performed. On the other hand, for the angular acceleration increase end point N1e, the angular acceleration decrease start point N2s, the angular acceleration increase end point N3e, and the angular acceleration decrease start point N4s, at which the angular velocity exceeds Vmax, the adjustment to increase the deflection angular velocity feedback gain coefficient Kgpc with each of the points as the starting point is not performed. With such processing, even when the inertial sensor 24 with an insufficient angular velocity detection range is used, a sufficient vibration suppression effect can be exhibited.

Even in the tenth embodiment as described above, the same effect as that of the first embodiment described above can be exhibited.

### Eleventh Embodiment

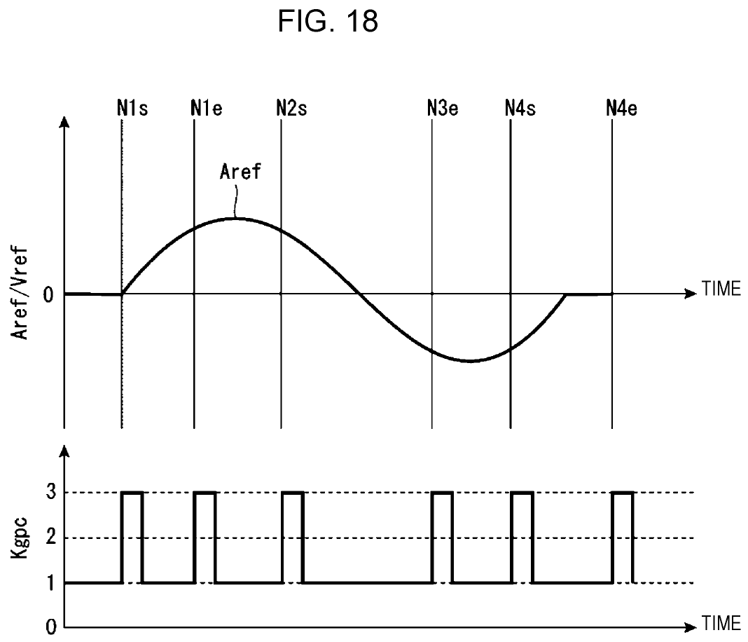

FIG. 18 is a timing chart illustrating an example of processing of adjusting the deflection angular velocity feedback gain Kgp performed in a robot system according to an eleventh embodiment.

The present embodiment is the same as the first embodiment described above except that the processing of adjusting the deflection angular velocity feedback gain Kgp is different. In the following description, the present embodiment will be described with a focus on differences from the first embodiment described above, and the description of the same matters will not be repeated. In addition, in the drawings of the present embodiment, the same configurations as those of the embodiment described above are denoted by the same reference numerals.

In the present embodiment, conditions for adjusting the deflection angular velocity feedback gain Kgp are switched between when the arm 22 performs the point-to-point (PTP) operation and when the arm 22 performs a continuous path (CP) operation. All of the embodiments described above describe where the arm 22 performs the PTP operation. On the other hand, FIG. 18 illustrates an angular acceleration change when the arm 22 performs the CP operation. As can be seen from FIG. 18, when the arm 22 performs the CP operation, the angular acceleration continuously changes. That is, there are an infinite number of continuous angular acceleration change points. In such a case, when the adjustment to increase the deflection angular velocity feedback gain coefficient Kgpc is performed in the same manner as when the arm 22 performs the PTP operation, a state in which the deflection angular velocity feedback gain Kgp is high is continuously maintained, which may lead to the destabilization of control. In that respect, by switching the conditions for adjusting the deflection angular velocity feedback gain Kgp between the CP operation and the PTP operation, the destabilization of control during the CP operation can be suppressed, and the vibration suppression effect can be obtained.

As described above, in the control method of the robot 2 of the present embodiment, in the first feedback gain adjustment step S2, the conditions for adjusting the deflection angular velocity feedback gain Kgp are varied between when the arm 22 performs the CP operation and when the arm 22 performs the PTP operation. As a result, the destabilization of control during the CP operation can be suppressed, and the vibration suppression effect can be obtained.

Even in the eleventh embodiment as described above, the same effect as that of the first embodiment described above can be exhibited.

### Twelfth Embodiment

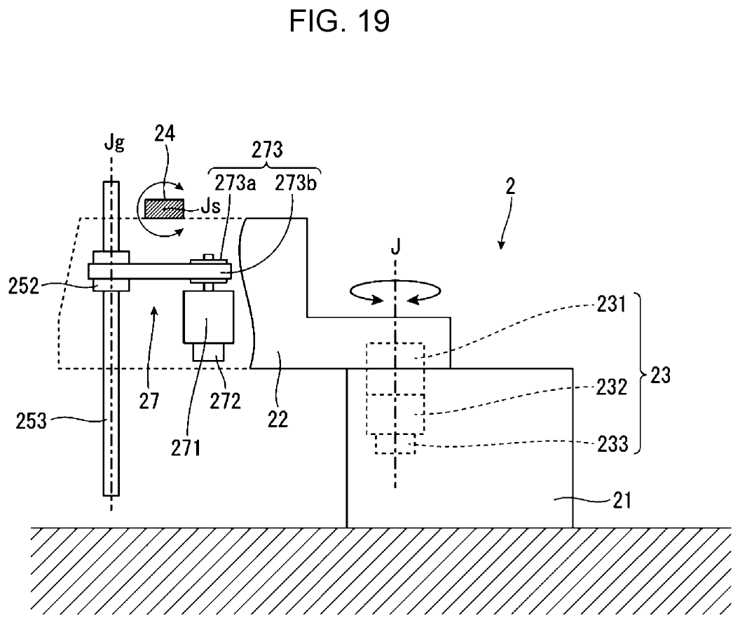

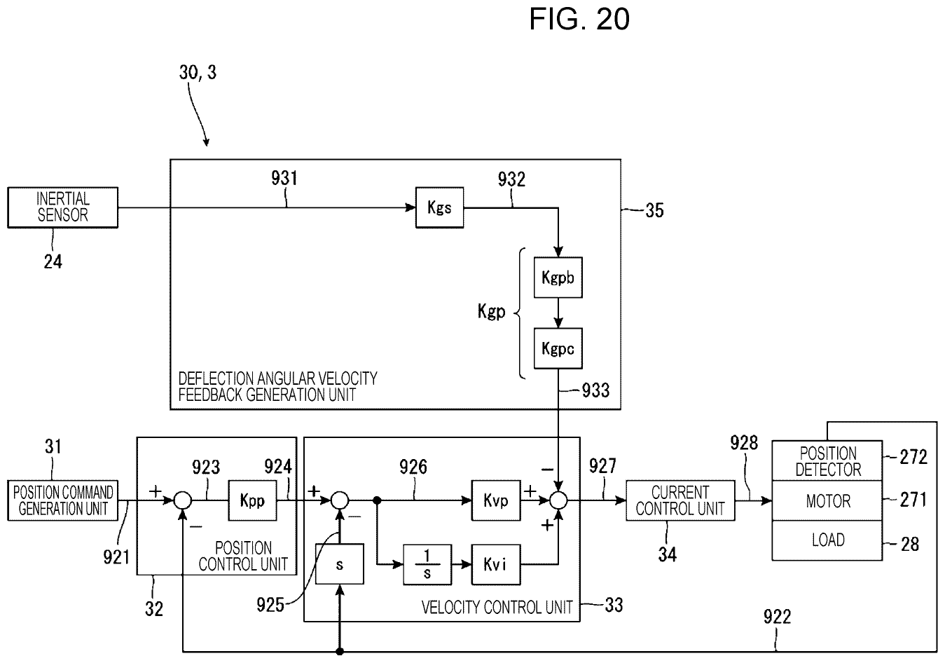

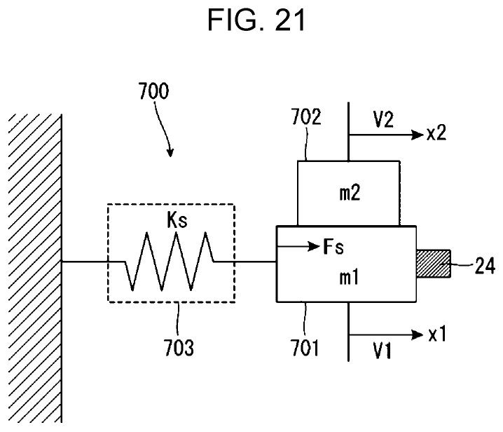

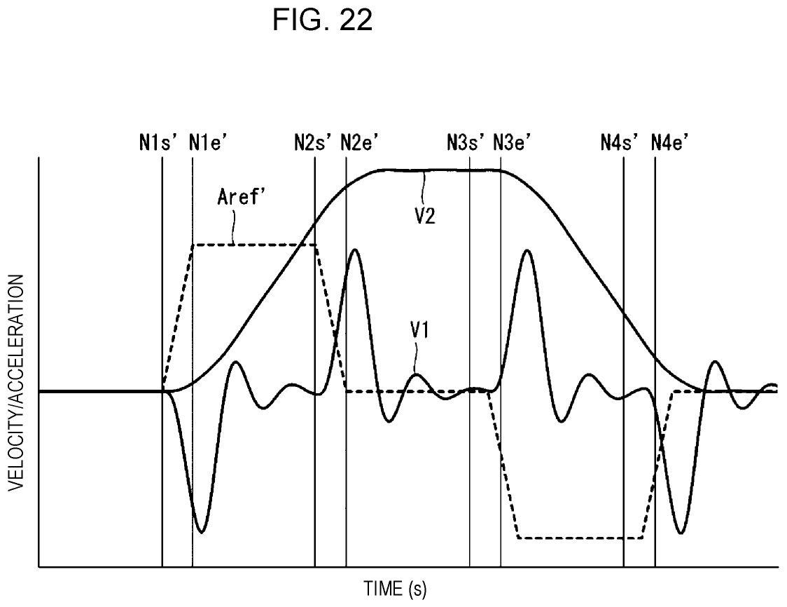

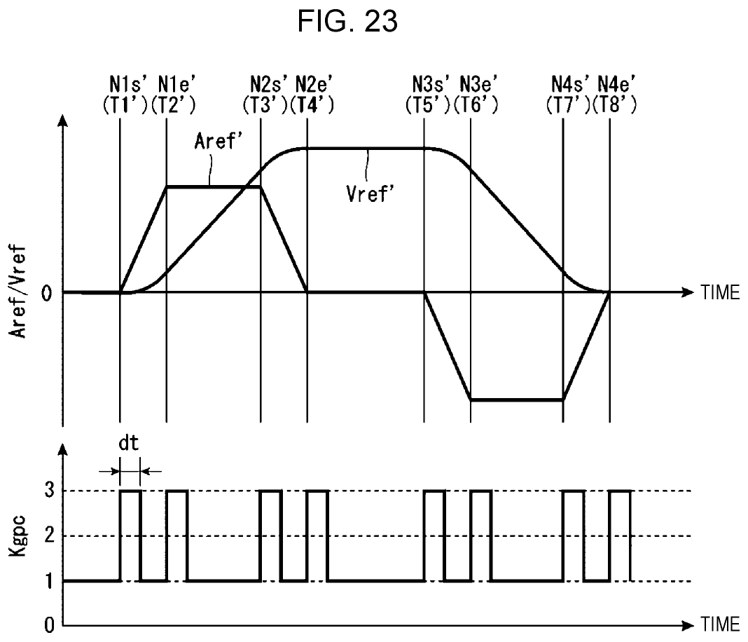

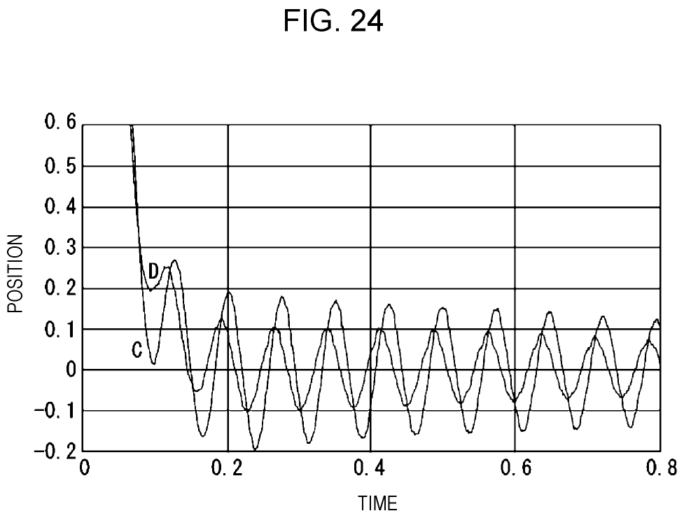

FIG. 19 is a diagram illustrating a robot provided in a robot system according to a twelfth embodiment. FIG. 20 is a block diagram illustrating a controller provided in the robot system of FIG. 19. FIG. 21 is a diagram illustrating a two-inertia system model of a linear movement portion of the robot. FIG. 22 is a graph illustrating changes in an acceleration command Aref′, a velocity V1, and a velocity V2 during an operation of a spline shaft. FIG. 23 is a timing chart illustrating an example of processing of adjusting the deflection angular velocity feedback gain Kgp. FIG. 24 is a graph illustrating a residual vibration suppression effect of the spline shaft.

The present embodiment is the same as the first embodiment described above except that the configuration of the robot 2 is different. In the following description, the present embodiment will be described with a focus on differences from the first embodiment described above, and the description of the same matters will not be repeated. In addition, in each of the drawings of the present embodiment, the same configurations as those of the embodiment described above are denoted by the same reference numerals.

### Robot 2

As illustrated in FIG. 19, the robot 2 further includes a spline shaft 253 as a movement portion disposed at the tip end portion of the arm 22, and a ball screw nut 252. When the ball screw nut 252 rotates, the spline shaft 253 is raised and lowered along a central axis Jg of the spline shaft 253. An end effector suitable for an intended work is mounted on the tip end portion (lower end portion) of the spline shaft 253.

In addition, the robot 2 further includes a drive mechanism 27 that rotates the ball screw nut 252 to raise and lower the spline shaft 253. The drive mechanism 27 includes a motor 271, a position detector 272 that detects a rotation angle of a rotary shaft of the motor 271, and a power transmission mechanism 273 that transmits power of the motor 271 to the ball screw nut 252. The power transmission mechanism 273 includes a pulley 273a mounted on the rotary shaft of the motor 271 and a timing belt 273b wound around the pulley 273a and the ball screw nut 252. In reality, a spline nut and a drive mechanism that rotates the spline nut to rotate the spline shaft 253 around the central axis Jg are provided. However, since this is not closely related to the present embodiment, the description and illustration thereof are omitted.

In addition, the inertial sensor 24 attached to the arm 22 is an angular velocity sensor that detects an angular velocity around a detection axis Js that is orthogonal to an extension direction of the arm 22 and the central axis Jg.

### Control Device 3

In the controller 30 illustrated in FIG. 20, the deflection angular velocity feedback generation unit 35 first obtains a deflection angular velocity 932 by multiplying an angular velocity 931 of the arm 22, which is detected by the inertial sensor 24, by the arm angular velocity scaling coefficient Kgs. Next, the deflection angular velocity feedback generation unit 35 obtains a deflection angular velocity feedback 933 by multiplying the deflection angular velocity 932 by the deflection angular velocity feedback gain Kgp (the deflection angular velocity feedback base gain Kgpb and the deflection angular velocity feedback gain coefficient Kgpc).

The position command generation unit 31 generates a position command 921 for the motor 271 based on the program created by the host computer 4.

The position control unit 32 first obtains a position deviation 923 obtained by subtracting a motor shaft position 922, which is the rotation angle of the motor 271 detected by the position detector 272, from the position command 921. Next, the position control unit 32 obtains a velocity command 924 by multiplying the position deviation 923 by the position loop proportional gain Kpp.

The velocity control unit 33 is configured with proportional-integral control. The velocity control unit 33 first obtains a motor shaft angular velocity 925, which is an angular velocity of the motor shaft, by time-differentiating the motor shaft position 922 detected by the position detector 272. Next, the velocity control unit 33 obtains a velocity deviation 926 obtained by subtracting the motor shaft angular velocity 925 from the velocity command 924. Next, the velocity control unit 33 obtains a current command 927 by adding an integral term, which is obtained by multiplying an integral value of the velocity deviation 926 by the velocity loop integral gain Kvi, to a proportional term, which is obtained by multiplying the velocity deviation 926 by the velocity loop proportional gain Kvp, and further subtracting the deflection angular velocity feedback 933.

The current control unit 34 controls a current 928 for driving the motor 271 to match the current command 927, that is, controls the current 928 to follow the current command 927. The motor 271 is driven by the current 928 controlled by the current control unit 34, and a load 28 coupled to the motor 271 linearly moves. Here, the load 28 is mainly the sum of the inertial masses of the motor shaft, the drive mechanism 27, the ball screw nut 252, and the spline shaft 253.

The circuit configuration of the controller 30 is briefly described above. Next, FIG. 21 illustrates a two-inertia system model 700 of the linear movement portion of the robot 2. In such a two-inertia system model 700, a driving element 702 having an inertial mass m2 is disposed on a base element 701 having an inertial mass m1, and the base element 701 is coupled to an installation surface via a spring element 703 having a spring constant Ks. The inertial sensor 24 is disposed on the base element 701 and detects the velocity V1 of the base element 701 in an x1 direction.

In the robot 2, the spring element 703 mainly corresponds to the rigidity of the vertical displacement (displacement in the direction along the rotational movement axis J) of the base 21 and the arm 22. In addition, in the robot 2, the base element 701 is mainly configured with the base 21 and the arm 22. Further, in the robot 2, the driving element 702 is mainly configured with the spline shaft 253. When the driving element 702 operates, a reaction force acts on the base element 701 that supports the driving element 702, and the base element 701 is displaced. A thrust force Fs proportional to the displacement of the spring element 703 acts on the base element 701.

The main cause of the vibration of the tip end portion of the spline shaft 253 in the direction along the central axis Jg is the vibration of the tip end portion of the arm 22. In that respect, by using the deflection angular velocity feedback 933, which is obtained by multiplying the deflection angular velocity 932 detected by the inertial sensor 24 by the deflection angular velocity feedback gain Kgp, for the control of the motor 271, the vibration of the arm 22 can be damped by using the reaction force for driving the spline shaft 253.

FIG. 22 illustrates changes in the acceleration command Aref′, the velocity V2 of the driving element 702, and the velocity V1 of the base element 701 during the point-to-point (PTP) operation of the arm 22. As illustrated in FIG. 22, the acceleration command Aref′ changes at an acceleration increase start point N1s′ and an acceleration increase end point N1e′ at the start of acceleration, at an acceleration decrease start point N2s′ and an acceleration decrease end point N2e′ at the end of acceleration, at an acceleration increase start point N3s′ and an acceleration increase end point N3e′ at the start of deceleration, and at an acceleration decrease start point N4s′ and an acceleration decrease end point N4e′ at the end of deceleration. In addition, there is a constant velocity section between the acceleration decrease end point N2e′ and the acceleration increase start point N3s′.

The vibration of the velocity V1 (hereinafter, also referred to as “deflection vibration”) increases with an acceleration change point at which the acceleration command Aref′ changes, that is, the acceleration increase start point N1s′, the acceleration increase end point N1e′, the acceleration decrease start point N2s′, the acceleration decrease end point N2e′, the acceleration increase start point N3s′, the acceleration increase end point N3e′, the acceleration decrease start point N4s′, and the acceleration decrease end point N4e′, as the starting points. This is a phenomenon that occurs when the reaction force caused by the acceleration and deceleration of the driving element 702 acts on the base element 701.

In that respect, in the robot system 1, the deflection angular velocity feedback gain Kgp is increased at a timing determined based on each of the above-described eight points N1s′, N1e′, N2s′, N2e′, N3s′, N3e′, N4s′, and N4e′ at which the deflection vibration of the velocity V1 increases, thereby reducing the vibration of the base element 701, that is, the arm 22.

Specifically, the deflection angular velocity feedback gain Kgp is increased with a first timing T1′ determined based on the acceleration increase start point N1s′, a second timing T2′ determined based on the acceleration increase end point N1e′, a third timing T3′ determined based on the acceleration decrease start point N2s′, a fourth timing T4′ determined based on the acceleration decrease end point N2e′, a fifth timing T5′ determined based on the acceleration increase start point N3s′, a sixth timing T6′ determined based on the acceleration increase end point N3e′, a seventh timing T7′ determined based on the acceleration decrease start point N4s′, and an eighth timing T8′ determined based on the acceleration decrease end point N4e′, as the starting points, thereby reducing the vibration of the arm 22.

In the present embodiment, the first timing T1′ is set at the same time point as the acceleration increase start point N1s′, the second timing T2′ is set at the same time point as the acceleration increase end point N1e′, the third timing T3′ is set at the same time point as the acceleration decrease start point N2s′, the fourth timing T4′ is set at the same time point as the acceleration decrease end point N2e′, the fifth timing T5′ is set at the same time point as the acceleration increase start point N3s′, the sixth timing T6′ is set at the same time point as the acceleration increase end point N3e′, the seventh timing T7′ is set at the same time point as the acceleration decrease start point N4s′, and the eighth timing T8′ is set at the same time point as the acceleration decrease end point N4e′. As a result, the deflection angular velocity feedback gain Kgp can be increased without delay for each of the acceleration change points: the acceleration increase start point N1s′, the acceleration increase end point N1e′, the acceleration decrease start point N2s′, the acceleration decrease end point N2e′, the acceleration increase start point N3s′, the acceleration increase end point N3e′, the acceleration decrease start point N4s′, and the acceleration decrease end point N4e′, thereby obtaining a higher vibration suppression effect.

However, the present disclosure is not limited thereto, and for example, the first timing T1′ may be a time point that is later by the predetermined time Δt from the acceleration increase start point N1s′, or may be a time point that is earlier by the predetermined time Δt from the acceleration increase start point N1s′. The same applies to the second, third, fourth, fifth, sixth, seventh, and eighth timings T2′, T3′, T4′, T5′, T6′, T7′, and T8′ other than the first timing T1′. In addition, the predetermined time Δt may be different between two or more timings optionally selected from the first, second, third, fourth, fifth, sixth, seventh, and eighth timings T1′, T2′, T3′, T4′, T5′, T6′, T7′, and T8′.

Hereinafter, for convenience of description, the first timing T1′ will be described as the acceleration increase start point N1s′, the second timing T2′ will be described as the acceleration increase end point N1e′, the third timing T3′ will be described as the acceleration decrease start point N2s′, the fourth timing T4′ will be described as the acceleration decrease end point N2e′, the fifth timing T5′ will be described as the acceleration increase start point N3s′, the sixth timing T6 will be described as the acceleration increase end point N3e′, the seventh timing T7′ will be described as the acceleration decrease start point N4s′, and the eighth timing T8′ will be described as the acceleration decrease end point N4e′.

Here, as destabilization factors of control that may occur by increasing the deflection angular velocity feedback gain Kgp, for example, (A) physical control destabilization due to elements constituting a drive system, and (B) decreased control stability due to wrap-around of vibrations in directions different from a linear movement direction are considered. The destabilization factor (A) refers to destabilization of control of the deflection angular velocity feedback determined by the inertial mass m2 of the driving element 702, the inertial mass m1 of the base element 701, and the spring constant Ks in the two-inertia system model 700. Meanwhile, the destabilization factor (B) refers to destabilization of control of the deflection angular velocity feedback occurring when the arm 22 vibrates in the directions different from the linear movement direction of the spline shaft 253 because of elastic deformation of each element constituting the robot 2, the inertial sensor 24 detects the vibration (hereinafter, also referred to as “vibration in a non-linear movement direction”) as noise, and the controller 30 uses the noise in the control. The vibration in the non-linear movement direction occurs due to the wrap-around of the deflection vibration in the linear movement direction. Therefore, the vibration in the non-linear movement direction increases with a delay relative to the deflection vibration in the linear movement direction.

In that respect, in the robot system 1, by utilizing the characteristic that the vibration in the non-linear movement direction increases with a delay relative to the deflection vibration in the linear movement direction, the deflection angular velocity feedback gain Kgp is temporarily increased with the above-described eight acceleration change points at which the deflection vibration in the linear movement direction increases, that is, the acceleration increase start point N1s′, the acceleration increase end point N1e′, the acceleration decrease start point N2s′, the acceleration decrease end point N2e′, the acceleration increase start point N3s′, the acceleration increase end point N3e′, the acceleration decrease start point N4s′, and the acceleration decrease end point N4e′, as the starting points to damp the deflection vibration in the linear movement direction, thereby suppressing the destabilization of control due to the amplification of the vibration in the non-linear movement direction. As described above, by temporarily increasing the deflection angular velocity feedback gain Kgp, the deflection angular velocity feedback gain Kgp can be decreased again when the vibration in the non-linear movement direction increases, thereby reducing, or preferably eliminating, the influence of the destabilization factor (B).

In the related art, because of the destabilization factor (B), the deflection angular velocity feedback gain Kgp cannot be increased to a limit value (maximum value) of the destabilization factor (A). On the other hand, with the control method of the present embodiment as described above, the influence of the destabilization factor (B) is reduced as described above, so that the deflection angular velocity feedback gain Kgp can be increased to the limit value of the destabilization factor (A). Therefore, the deflection angular velocity feedback gain Kgp can be set to be higher than that in the related art without causing the destabilization of control, and the vibration suppression effect of the arm 22 can be enhanced.

FIG. 23 is a timing chart illustrating an example of processing of adjusting the deflection angular velocity feedback gain Kgp with the above-described eight points which are the change points of the acceleration command Aref′, that is, the acceleration increase start point N1s′, the acceleration increase end point N1e′, the acceleration decrease start point N2s′, the acceleration decrease end point N2e′, the acceleration increase start point N3s′, the acceleration increase end point N3e′, the acceleration decrease start point N4s′, and the acceleration decrease end point N4e′, as the starting points. FIG. 23 illustrates changes in the acceleration command Aref′, a velocity command Vref′, and the deflection angular velocity feedback gain coefficient Kgpc.

In the illustrated example, the deflection angular velocity feedback gain coefficient Kgpc is increased from 1, which is the reference value, to 3 for dt seconds with all the points: the acceleration increase start point N1s′, the acceleration increase end point N1e′, the acceleration decrease start point N2s′, the acceleration decrease end point N2e′, the acceleration increase start point N3s′, the acceleration increase end point N3e′, the acceleration decrease start point N4s′, and the acceleration decrease end point N4e′, as the starting points. The deflection angular velocity feedback gain coefficient Kgpc is increased from 1 to 3, and then the deflection angular velocity feedback gain coefficient Kgpc is decreased from 3 to 1, that is, to the reference value, after the elapse of dt seconds. Therefore, the controller 30 controls the drive of the motor 271 by using the deflection angular velocity feedback gain coefficient Kgpc=3 until the deflection angular velocity feedback gain coefficient Kgpc is increased from 1 to 3 and then decreased to 1 again, and controls the drive of the motor 271 by using the deflection angular velocity feedback gain coefficient Kgpc=1 at other times.

The deflection angular velocity feedback gain Kgp is obtained by multiplying the deflection angular velocity feedback base gain Kgpb by the deflection angular velocity feedback gain coefficient Kgpc as shown in Equation (2) above. Therefore, while the deflection angular velocity feedback gain coefficient Kgpc is increased to 3, the deflection angular velocity feedback gain Kgp is increased by three times. By increasing the deflection angular velocity feedback gain Kgp by three times, the effect of damping the deflection vibration is increased, and it is possible to reduce the deflection vibration that increases during operation with each of the acceleration change points: the acceleration increase start point N1s′, the acceleration increase end point N1e′, the acceleration decrease start point N2s′, the acceleration decrease end point N2e′, the acceleration increase start point N3s′, and the acceleration increase end point N3e′, as the starting points, and the residual vibration that increases after stopping with each of the acceleration change points: the acceleration decrease start point N4s′ and the acceleration decrease end point N4e′, as the starting points.

The adjustment of the deflection angular velocity feedback gain coefficient Kgpc at the acceleration increase start point N1s′ and the acceleration increase end point N1e′ has the effect of reducing the deflection vibration of the spline shaft 253 during the acceleration operation. In addition, the adjustment of the deflection angular velocity feedback gain coefficient Kgpc at the acceleration decrease start point N2s′ and the acceleration decrease end point N2e′ has the effect of reducing the deflection vibration of the spline shaft 253 during the constant velocity operation. Further, the adjustment of the deflection angular velocity feedback gain coefficient Kgpc at the acceleration increase start point N3s′ and the acceleration increase end point N3e′ has the effect of reducing the deflection vibration of the spline shaft 253 during the deceleration operation. Furthermore, the adjustment of the deflection angular velocity feedback gain coefficient Kgpc at the acceleration decrease start point N4s′ and the acceleration decrease end point N4e′ has the effect of reducing the residual vibration of the spline shaft 253.

In the illustrated example, the deflection angular velocity feedback gain coefficient Kgpc is increased from 1 to 3 with all the points: the acceleration increase start point N1s′, the acceleration increase end point N1e′, the acceleration decrease start point N2s′, the acceleration decrease end point N2e′, the acceleration increase start point N3s′, the acceleration increase end point N3e′, the acceleration decrease start point N4s′, and the acceleration decrease end point N4e′, as the starting points, but the present disclosure is not limited thereto, and the deflection angular velocity feedback gain coefficient Kgpc need only be increased from 1 to 3 with at least one of the eight points as the starting point. Consequently, at least the deflection vibration that increases with the point as the starting point can be effectively suppressed. In addition, in the illustrated example, the deflection angular velocity feedback gain coefficient Kgpc is increased to 3, but the value of the deflection angular velocity feedback gain coefficient Kgpc is not particularly limited.

FIG. 24 is a graph illustrating the residual vibration suppression effect of the tip end portion of the spline shaft 253 and compares the residual vibration in the linear movement direction occurring in the tip end portion of the spline shaft 253 between C, where the deflection angular velocity feedback gain Kgp is kept constant, and D, where the deflection angular velocity feedback gain Kgp is changed in synchronization with the acceleration change as in the present embodiment. It can be seen from FIG. 24 that the overshoot is reduced in the present embodiment, and an excellent vibration suppression effect is exhibited.

As described above, the robot system 1 in the present embodiment includes the spline shaft 253 as the movement portion that linearly moves along a predetermined operating direction with respect to the arm 22. In addition, the inertial sensor 24 detects the angular velocity around the detection axis Js, which is a direction orthogonal to the operating direction of the spline shaft 253. The angular velocity is caused by the elastic deformation of the arm 22. Further, the controller 30 obtains the deflection angular velocity 932 based on the angular velocity of the arm 22 detected by the inertial sensor 24 and multiplies the deflection angular velocity 932 by the deflection angular velocity feedback gain Kgp. By using the deflection angular velocity feedback 933 obtained in this manner, the vibration suppression effect of the spline shaft 253 can be enhanced.

Even in the twelfth embodiment as described above, the same effect as that of the first embodiment described above can be exhibited.

In the present embodiment, the processing of adjusting the deflection angular velocity feedback gain Kgp is the same as the processing of the first embodiment described above, but the present disclosure is not limited thereto, and the method of the processing described in the second to eleventh embodiments described above can also be applied. As a result, the same effects as those described in each of the embodiments can be exhibited.

### Thirteenth Embodiment

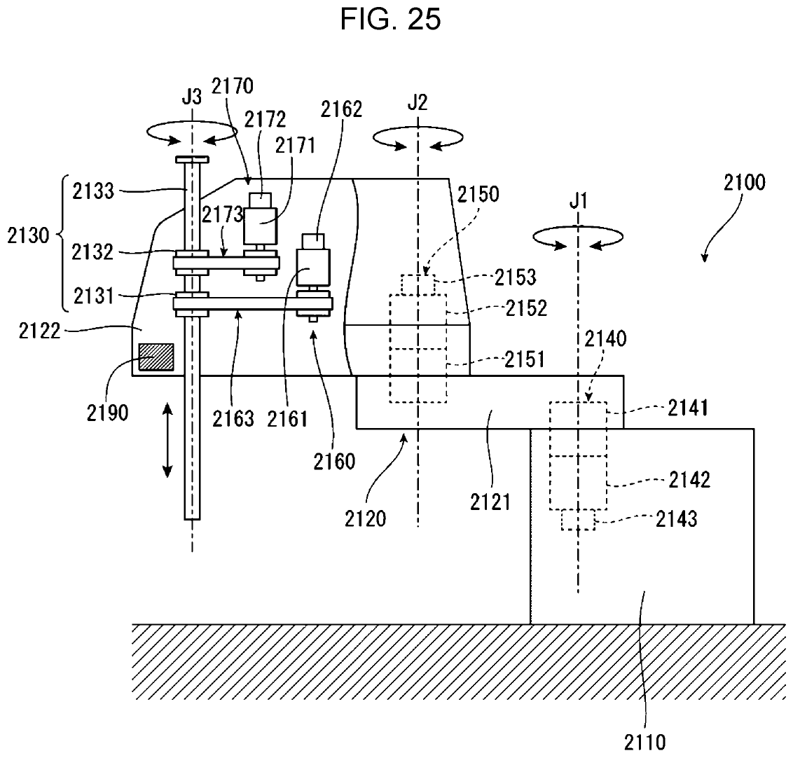

FIG. 25 is a diagram illustrating a robot provided in a robot system according to a thirteenth embodiment.

The present embodiment is the same as the first embodiment described above except that the configuration of the robot is different. In the following description, the present embodiment will be described with a focus on differences from the first embodiment described above, and the description of the same matters will not be repeated. In addition, in the drawings of the present embodiment, the same configurations as those of the embodiment described above are denoted by the same reference numerals.

As illustrated in FIG. 25, a robot 2100 of the present embodiment is a horizontal articulated robot (SCARA robot) and includes a base 2110 fixed to the floor and an arm 2120 coupled to the base 2110. In addition, the arm 2120 includes a first arm 2121 that includes a base end portion coupled to the base 2110 and that rotationally moves around a first rotational movement axis J1 with respect to the base 2110, and a second arm 2122 that includes a base end portion coupled to a tip end portion of the first arm 2121 and that rotationally moves around a second rotational movement axis J2 parallel to the first rotational movement axis J1 with respect to the first arm 2121. An inertial sensor 2190 that detects an angular velocity around an axis along the vertical direction and an angular velocity around an axis orthogonal to the vertical direction is disposed on the second arm 2122.

Further, a working head 2130 is provided at the tip end portion of the second arm 2122. The working head 2130 includes a spline nut 2131 and a ball screw nut 2132 coaxially disposed at the tip end portion of the second arm 2122, and a spline shaft 2133 inserted through the spline nut 2131 and the ball screw nut 2132. The spline shaft 2133 rotates around a third rotational movement axis J3, which is a central axis of the spline shaft 2133, with respect to the second arm 2122, and is raised and lowered along the third rotational movement axis J3. An end effector suitable for the work is mounted on a lower end portion (tip end portion) of the spline shaft 2133. The third rotational movement axis J3 is parallel to the first rotational movement axis J1 and the second rotational movement axis J2 and extends along the vertical direction.

In addition, the robot 2100 includes a drive mechanism 2140 that rotationally moves the first arm 2121 around the first rotational movement axis J1 with respect to the base 2110, and a drive mechanism 2150 that rotationally moves the second arm 2122 around the second rotational movement axis J2 with respect to the first arm 2121. The drive mechanism 2140 and the drive mechanism 2150 have the same configuration as that of the drive mechanism 23 described above. That is, the drive mechanism 2140 includes a reducer 2141 that couples the base 2110 and the first arm 2121, a motor 2142 that includes a rotary shaft coupled to an input side of the reducer 2141, and a position detector 2143 that detects a rotation angle of the rotary shaft of the motor 2142. Similarly, the drive mechanism 2150 includes a reducer 2151 that couples the first arm 2121 and the second arm 2122, a motor 2152 that includes a rotary shaft coupled to an input side of the reducer 2151, and a position detector 2153 that detects a rotation angle of the rotary shaft of the motor 2152.

Further, the robot 2100 includes a drive device 2160 that rotates the spline nut 2131 to rotate the spline shaft 2133 around the third rotational movement axis J3, and a drive device 2170 that rotates the ball screw nut 2132 to raise and lower the spline shaft 2133 along the third rotational movement axis J3. The drive devices 2160 and 2170 have the same configuration as that of the drive mechanism 27 described above. That is, the drive device 2160 includes a motor 2161, a position detector 2162 that detects a rotation angle of a rotary shaft of the motor 2161, and a power transmission mechanism 2163 that transmits power of the motor 2161 to the spline nut 2131. Similarly, the drive device 2170 includes a motor 2171, a position detector 2172 that detects a rotation angle of a rotary shaft of the motor 2171, and a power transmission mechanism 2173 that transmits power of the motor 2171 to the ball screw nut 2132.

In the robot 2100 having the configuration as described above, by using the control method of the first to eleventh embodiments described above to control the motors 2142 and 2152 for driving the first and second arms 2121 and 2122, the vibrations of the first and second arms 2121 and 2122 can be effectively suppressed.

The deflection angular velocity 914 of the first arm 2121 can be obtained by subtracting the motor shaft angular velocity 913 of the motor 2152 that drives the second arm 2122 and the motor shaft angular velocity 913 of the motor 2142 that drives the first arm 2121 from the angular velocity detected by the inertial sensor 2190.

In addition, the deflection angular velocity 914 of the second arm 2122 can be obtained by subtracting the motor shaft angular velocity 913 of the motor 2142 that drives the first arm 2121 and the motor shaft angular velocity 913 of the motor 2152 that drives the second arm 2122 from the angular velocity detected by the inertial sensor 2190.

Further, in the robot 2100 having the configuration as described above, the control method of the twelfth embodiment described above can also be used to control the motor 2171 for raising and lowering the spline shaft 2133 along the third rotational movement axis J3.

With such a configuration, the vibration of the tip end portion of the spline shaft 2133 can be effectively suppressed.

Even in the thirteenth embodiment as described above, the same effect as that of the first embodiment described above can be exhibited.

### Fourteenth Embodiment

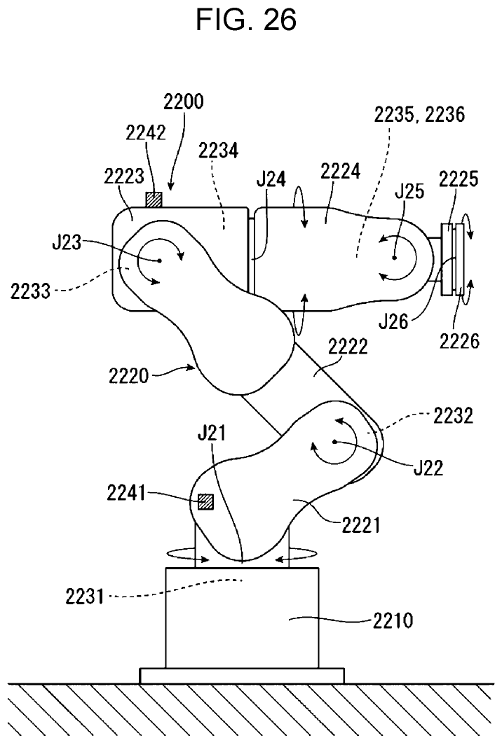

FIG. 26 is a diagram illustrating a robot provided in a robot system according to a fourteenth embodiment.

The present embodiment is the same as the first embodiment described above except that the configuration of the robot is different. In the following description, the present embodiment will be described with a focus on differences from the first embodiment described above, and the description of the same matters will not be repeated. In addition, in the drawings of the present embodiment, the same configurations as those of the embodiment described above are denoted by the same reference numerals.

As illustrated in FIG. 26, a robot 2200 of the present embodiment is a six-axis vertical articulated robot including six drive axes and includes a base 2210 fixed to the floor and an arm 2220 coupled to the base 2210 to be rotationally movable. In addition, the arm 2220 is configured such that a first arm 2221, a second arm 2222, a third arm 2223, a fourth arm 2224, a fifth arm 2225, and a sixth arm 2226 are coupled from a base 2210 side to be rotationally movable. An end effector suitable for the work is mounted on the sixth arm 2226.

Further, the robot 2200 includes a drive mechanism 2231 that rotationally moves the first arm 2221 around a first rotational movement axis J21 with respect to the base 2210, a drive mechanism 2232 that rotationally moves the second arm 2222 around a second rotational movement axis J22 with respect to the first arm 2221, a drive mechanism 2233 that rotationally moves the third arm 2223 around a third rotational movement axis J23 with respect to the second arm 2222, a drive mechanism 2234 that rotationally moves the fourth arm 2224 around a fourth rotational movement axis J24 with respect to the third arm 2223, a drive mechanism 2235 that rotationally moves the fifth arm 2225 around a fifth rotational movement axis J25 with respect to the fourth arm 2224, and a drive mechanism 2236 that rotationally moves the sixth arm 2226 around a sixth rotational movement axis J26 with respect to the fifth arm 2225.

Although not illustrated, each of the drive mechanisms 2231, 2232, 2233, 2234, 2235, and 2236 has the same configuration as that of the drive mechanism 23 described above and includes a reducer, a motor including a rotary shaft coupled to an input side of the reducer, and a position detector that detects a rotation angle of the rotary shaft of the motor.

Additionally, the robot 2200 also includes an inertial sensor 2241 disposed on the first arm 2221 and an inertial sensor 2242 disposed on the third arm 2223. The inertial sensor 2241 detects an angular velocity of the first arm 2221 around the first rotational movement axis J21. The inertial sensor 2242 detects a combined angular velocity of an angular velocity of the second arm 2222 around the second rotational movement axis J22 and an angular velocity of the third arm 2223 around the third rotational movement axis J23.

In the robot 2200 having the configuration as described above, by using the control method of the first to eleventh embodiments described above to control the motors for driving the first and second arms 2221 and 2222, the vibrations of the first and second arms 2221 and 2222 can be effectively suppressed.

The deflection angular velocity 914 of the first arm 2221 can be obtained by subtracting the motor shaft angular velocity 913 of the motor that drives the first arm 2221 from the angular velocity detected by the inertial sensor 2241. As a result, the vibration of the first arm 2221 can be effectively suppressed.

In addition, the deflection angular velocity 914 of the second arm 2222 can be obtained by subtracting the motor shaft angular velocity 913 of the motor that drives the third arm 2223 and the motor shaft angular velocity 913 of the motor that drives the second arm 2222 from the angular velocity detected by the inertial sensor 2242.

Further, the deflection angular velocity 914 of the third arm 2223 can be obtained by subtracting the motor shaft angular velocity 913 of the motor that drives the second arm 2222 and the motor shaft angular velocity 913 of the motor that drives the third arm 2223 from the angular velocity detected by the inertial sensor 2242.

With such a configuration, the vibration of the tip end portion of the arm 2220, that is, the sixth arm 2226, can be effectively suppressed.

Even in the fourteenth embodiment as described above, the same effect as that of the first embodiment described above can be exhibited.

The thirteenth embodiment described above describes an application example to the horizontal articulated robot, and the fourteenth embodiment describes an application example to the six-axis vertical articulated robot, but the present disclosure is not limited thereto. For example, the present disclosure may be applied to an orthogonal type robot or a seven-axis vertical articulated robot. The present disclosure may be applied to any robot including at least a rotational movement joint or a linear movement joint.

As described above, the control method of the robot and the robot system of the present disclosure are described based on the illustrated embodiments. However, the present disclosure is not limited thereto, and the configuration of each portion can be replaced with any configuration having the same function. Additionally, any other components may be added to the present disclosure.

1. A control method of a robot, comprising:
an inertial information reception step of receiving an output signal from an inertial sensor that measures an operation of an arm;
a first feedback gain adjustment step of performing adjustment to increase a feedback gain to be multiplied by the output signal or a signal generated from the output signal, according to a change in the operation of the arm;
a drive control step of controlling a drive of the arm by using the feedback gain increased in the first feedback gain adjustment step; and
a second feedback gain adjustment step of performing adjustment to decrease the feedback gain after elapse of a predetermined time from the first feedback gain adjustment step.

2. The control method of a robot according to claim 1, wherein
in the first feedback gain adjustment step, the feedback gain is changed from a reference value to a value higher than the reference value, and
in the second feedback gain adjustment step, the feedback gain is returned to the reference value.

3. The control method of a robot according to claim 1, wherein
the output signal includes inertial information which is information regarding inertia generated in the arm by the operation, and
the first feedback gain adjustment step is performed at at least one of
a first timing at which an increase in the inertial information starts at a start of acceleration of the arm,
a second timing at which the increase in the inertial information ends at the start of acceleration of the arm,
a third timing at which a decrease in the inertial information starts at an end of acceleration of the arm,
a fourth timing at which the decrease in the inertial information ends at the end of acceleration of the arm,
a fifth timing at which the increase in the inertial information starts at a start of deceleration of the arm,
a sixth timing at which the increase in the inertial information ends at the start of deceleration of the arm,
a seventh timing at which the decrease in the inertial information starts at an end of deceleration of the arm, and
an eighth timing at which the decrease in the inertial information ends at the end of deceleration of the arm.

4. The control method of a robot according to claim 1, wherein
the feedback gain is obtained by multiplying a feedback base gain, which is a reference for the feedback gain, by a feedback coefficient, and
in the first feedback gain adjustment step and the second feedback gain adjustment step, the feedback gain is adjusted by changing the feedback coefficient.

5. The control method of a robot according to claim 3, wherein
in the first feedback gain adjustment step, the feedback gain is adjusted to be different between any two timings selected from the first timing, the second timing, the third timing, the fourth timing, the fifth timing, the sixth timing, the seventh timing, and the eighth timing.

6. The control method of a robot according to claim 3, wherein
in the first feedback gain adjustment step, the predetermined time is different between any two timings selected from the first timing, the second timing, the third timing, the fourth timing, the fifth timing, the sixth timing, the seventh timing, and the eighth timing.

7. The control method of a robot according to claim 1, wherein
the change in the inertial information is detected based on a position command for the arm.

8. The control method of a robot according to claim 3, wherein
the first timing, the third timing, the fifth timing, and the seventh timing are timings at which the inertial information exceeds a threshold value.

9. The control method of a robot according to claim 1, wherein
in the first feedback gain adjustment step, conditions for adjusting the feedback gain are varied between when the arm performs a CP operation and when the arm performs a PTP operation.

10. A robot system comprising:
a base;
an arm that is driven with respect to the base;
an inertial sensor that detects an operation of the arm; and
a controller that controls the drive of the arm, wherein
the controller
receives an output signal from the inertial sensor,
performs adjustment to increase a feedback gain to be multiplied by the output signal or a signal generated from the output signal, according to a change in the operation of the arm,
controls the drive of the arm by using the feedback gain after the adjustment, and
performs adjustment to decrease the feedback gain after elapse of a predetermined time from the increase of the feedback gain.

11. The robot system according to claim 10, further comprising:
a motor that rotationally moves the arm around a rotational movement axis with respect to the base; and
a position detector that detects a rotation angle of the motor, wherein
the controller obtains a deflection angular velocity based on an angular velocity of the arm around the rotational movement axis, which is detected by the inertial sensor, and an angular velocity of the motor, which is detected by the position detector, and multiplies the deflection angular velocity by the feedback gain.

12. The robot system according to claim 10, further comprising:
a movement portion that linearly moves along a predetermined operating direction with respect to the arm, wherein
the inertial sensor detects an angular velocity in a direction orthogonal to the operating direction of the movement portion, the angular velocity being caused by elastic deformation of the arm, and
the controller obtains a deflection angular velocity based on an angular velocity of the arm, which is detected by the inertial sensor, and multiplies the deflection angular velocity by the feedback gain.
